(19) United States
(12) Patent Application Publication
(10) Pub. No.: US 2024/0330401 A1
(43) Pub. Date: Oct. 3, 2024

(54) GAUSSIAN ELIMINATION COMPUTING SYSTEM AND GAUSSIAN ELIMINATION COMPUTING METHOD

(71) Applicant: National Taiwan University, Taipei (TW)

(72) Inventors: Po-Jen Chen, Taipei (TW); Tsung-Hsien Yang, Taipei (TW); Ting Wang, Taipei (TW); Tsung-Te Liu, Taipei City (TW)

(73) Assignee: National Taiwan University, Taipei (TW)

(21) Appl. No.: 18/193,659

(22) Filed: Mar. 31, 2023

(51) Int. Cl. G06F 17/16

(52) U.S. Cl. CPC G06F 17/16

(57) ABSTRACT

A Gaussian elimination computing system and a Gaussian elimination computing method are provided. The Gaussian elimination computing system includes a control circuit, a systolic array, and a memory. The control circuit receives an operation matrix. The systolic array includes a square array formed by a plurality of operating cells. The systolic array is configured to perform a matrix decomposition operation to the operation matrix, to decompose the operation matrix into a lower triangular matrix and an upper triangular matrix. The memory is configured with an operation data block with the same size as the operation matrix for storing the lower triangular matrix and the upper triangular matrix after decomposition.

### BACKGROUND

### Technical Field

The disclosure relates to a system and a method, and in particular relates to a Gaussian elimination computing system and a Gaussian elimination computing method.

### Description of Related Art

In post-quantum cryptography, unlike quantum cryptography, post-quantum cryptography uses existing binary computers and does not rely on quantum mechanics. It relies on computationally difficult problems that cryptographers believe cannot be effectively solved by quantum computers to perform effective encryption.

### SUMMARY

A Gaussian elimination computing system and a Gaussian elimination computing method, which can save memory requirements when performing a matrix decomposition operation, are provided in the disclosure.

The Gaussian elimination computing system of the disclosure includes a control circuit, a systolic array, and a memory. The control circuit receives an operation matrix. The systolic array includes a square array formed by multiple operating cells. The systolic array is configured to perform a matrix decomposition operation to the operation matrix, to decompose the operation matrix into a lower triangular matrix and an upper triangular matrix. The memory is configured with an operation data block with the same size as the operation matrix for storing the lower triangular matrix and the upper triangular matrix after decomposition.

The Gaussian elimination computing method of the disclosure includes the following operation. An operation matrix is received. The operation matrix is input into a systolic array for matrix decomposition operation, and the operation matrix is decomposed into a lower triangular matrix and an upper triangular matrix. The memory is configured with an operation data block with the same size as the operation matrix, and the lower triangular matrix and the upper triangular matrix are stored in the operation data block after decomposition.

Based on the above, the Gaussian elimination computing system and the Gaussian elimination computing method of the disclosure may efficiently utilize the memory and improve the efficiency and hardware requirements required for computing.

### BRIEF DESCRIPTION OF THE DRAWINGS

FIG. 1 is a block schematic diagram of a Gaussian elimination computing system according to an embodiment of the disclosure.

FIG. 2A is a circuit block diagram of a systolic array according to an embodiment of the disclosure.

FIG. 2B and FIG. 2C are truth tables of the second operating cell and the first operating cell in FIG. 2A respectively.

FIG. 2D is a circuit schematic diagram of the error detection circuit in the first operating cell in FIG. 2A.

FIG. 3A is a block schematic diagram of a Gaussian elimination computing system according to an embodiment of the disclosure.

FIG. 3B is a circuit block diagram of the first control circuit in FIG. 3A.

FIG. 3C is a circuit block diagram of the sorting circuit in FIG. 3A.

FIG. 3D is a circuit block diagram of some of the multiplexers in FIG. 3A.

FIG. 4A to FIG. 4Z are the operation procedures of a systolic array performing a matrix decomposition operation on the first column group matrix.

FIG. 5A to FIG. 5C are schematic diagrams of the systolic array in FIG. 3A performing the writing process to the memory.

FIG. 6A to FIG. 6D are schematic diagrams of performing a matrix decomposition operation process to an operation matrix.

FIG. 7A to FIG. 7C are schematic diagrams of the computing process of how to multiply the inverse matrix of the lower triangular matrix and the sorting matrix by the target matrix.

FIG. 8A to FIG. 8C are schematic diagrams of how to perform computation according to the inverse matrix of the upper triangular matrix to obtain the public key matrix.

FIG. 9 is a flowchart of a Gaussian elimination computing method according to an embodiment of the disclosure.

### DETAILED DESCRIPTION OF DISCLOSED EMBODIMENTS

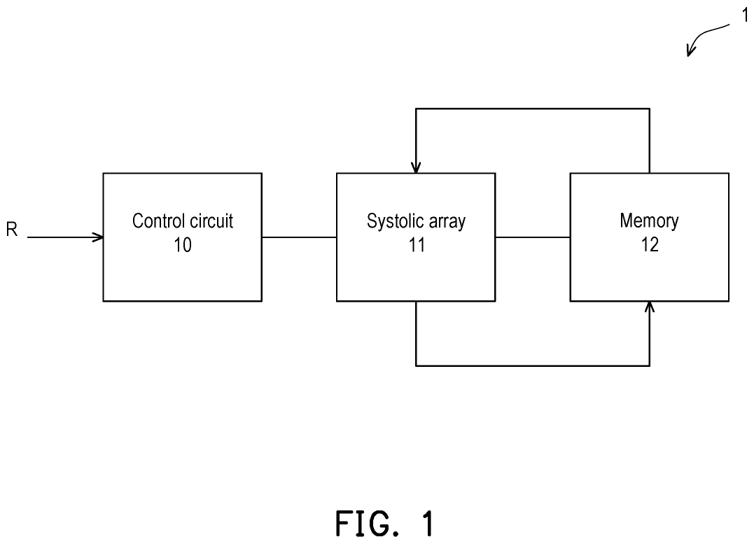

FIG. 1 is a block schematic diagram of a Gaussian elimination computing system 1 according to an embodiment of the disclosure. In some embodiments, the Gaussian elimination computing system 1 may be applied in post-quantum cryptography to receive an input matrix R and generate a public key for encryption according to a corresponding encryption algorithm. For example, the encryption algorithm may be McEliece, BIKE, FrodoKEM, HQC, NTRU Prime, or other suitable encryption algorithms. The input matrix R received by the Gaussian elimination computing system 1 may be a random number matrix generated randomly, and the input matrix R may be divided into an operation matrix M and a target matrix T by the input matrix R. In the operation matrix M and the target matrix T, the operation matrix M may be configured by the Gaussian elimination computing system 1 to compute the inverse matrix M⁻¹. The target matrix T is further operated based on the inverse matrix M⁻¹ to obtain the public key. In some embodiments, the Gaussian elimination computing system 1 may determine in real time whether the operation matrix M is full rank or whether the operation matrix M is invertible. In other words, the Gaussian elimination computing system 1 does not need to wait until the complete computing process of the inverse matrix M⁻¹ is completed to determine whether it has full rank or whether the inverse matrix M⁻¹ exists. On the contrary, when it is determined that the operation matrix M is not full rank or not invertible, the Gaussian elimination computing system 1 may abort the operation on the operation matrix M in the middle of the computing process, so as to achieve the early-abortion effect. For example, the Gaussian elimination computing system 1 may use naive abortion, square inversion, PLU decomposition, or other suitable algorithms to realize early-abortion during the operation process. On the other hand, the Gaussian elimination computing system 1 may save memory space during the operation, so that the Gaussian elimination computing system 1 may use the memory block with the same size as the operation matrix M to perform computation, avoiding extra burden on the memory capacity and the circuit area.

In general, the Gaussian elimination computing system 1 executes and computes the following Formula (1) to Formula (3) to compute the public key matrix PK according to the input matrix R.

$$PM = LU \qquad ( 1 )$$

$${U}^{- 1} \cdot {L}^{- 1} \cdot P \cdot M = I \qquad ( 2 )$$

$$PK = {U}^{- 1} \cdot {L}^{- 1} \cdot P \cdot T \qquad ( 3 )$$

Where P is the sorting matrix, M is the operation matrix, L is the lower triangular matrix, U is the upper triangular matrix, U⁻¹ is the inverse matrix of the upper triangular matrix, L⁻¹ is the inverse matrix of the lower triangular matrix, I is the identity matrix, PK is the public key matrix, and T is the target matrix. In detail, through the PLU decomposition, the operation matrix M may be decomposed into the relationships expressed in Formula (1) and Formula (2). Furthermore, by replaying the process of restoring the operation matrix M to the unit matrix in Formula (2) on the target matrix T, as shown in Formula (3), the target matrix T is operated through the matrix decomposition process of the operation matrix M, and the public key matrix PK is obtained.

In detail, the Gaussian elimination computing system 1 includes a control circuit 10, a systolic array 11, and a memory 12. The control circuit 10 may be configured to receive an n×m input matrix R (i.e., n rows and m columns), and divide the input matrix R into an n×n operation matrix M and an n×(m−n) target matrix T, where n<m. The systolic array 11 is coupled to the control circuit 10 and receives the operation matrix M. In this embodiment, the systolic array 11 may perform a matrix decomposition operation such as PLU decomposition on the operation matrix M to decompose the operation matrix M into a sorting matrix P, a lower triangular matrix L, and an upper triangular matrix U. In addition, the memory 12 may be configured with an operation data block with the same size as the operation matrix M. Therefore, the systolic array 11 may store the lower triangular matrix L and upper triangular matrix U in the operation data block with the same size as the operation matrix M in the memory 12 after decomposition.

In some embodiments, the systolic array 11 may be realized by using a systolic array, a systolic network, a systolic line, or other suitable computing architecture. In the following description of this embodiment, the systolic array 11 being decomposed by the PLU decomposition based on the systolic line architecture is taken as the example of the main description, but it should be understood that the above implementation should not be used as a basis for limiting the Gaussian elimination computing system 1 and the systolic array 11.

In some embodiments, when the control circuit 10 receives the n×m input matrix R, the control circuit 10 may first split the input matrix R into an n×n operation matrix M and an n×(m−n) target matrix T. Then, the control circuit 10 may further divide the operation matrix M into multiple n×p column group matrices, and compute the inverse matrix of the overall operation matrix M by respectively inputting the column group matrices to the systolic array 11.

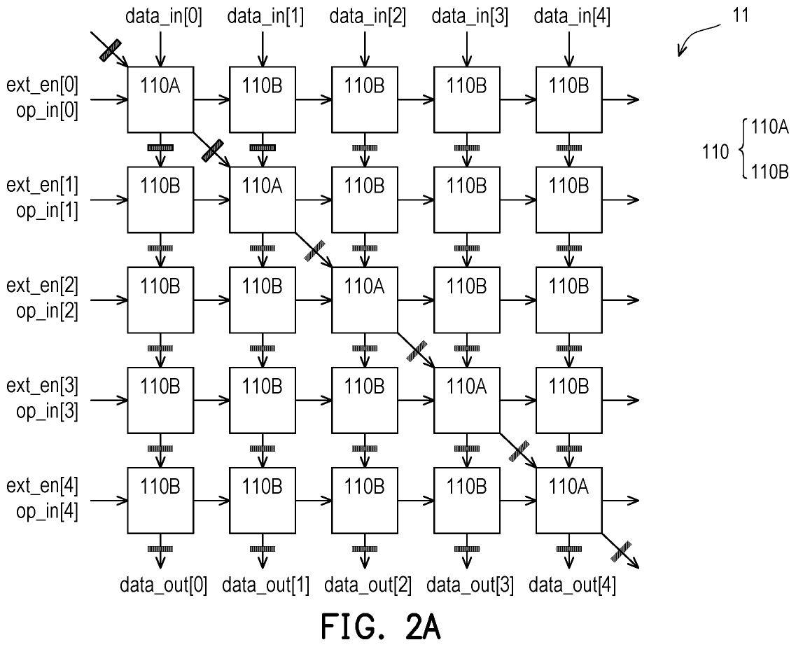

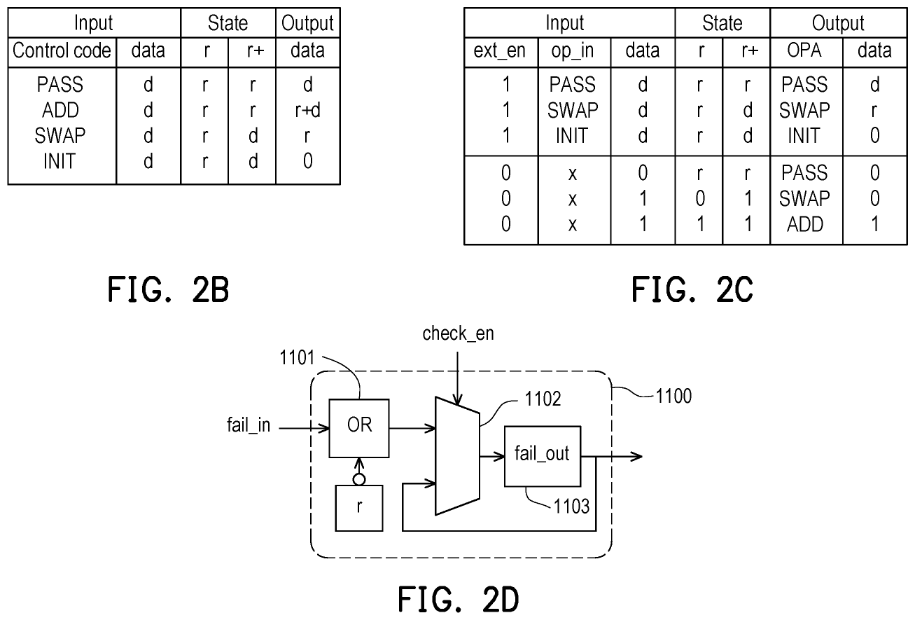

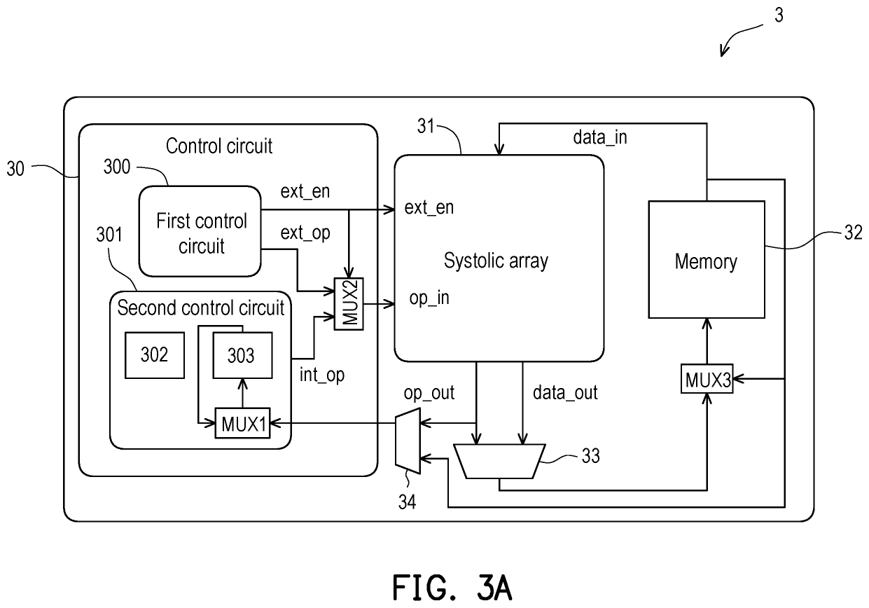

FIG. 2A is a circuit block diagram of a systolic array 11 according to an embodiment of the disclosure. In some embodiments, the systolic array 11 may, for example, have a circuit block structure as shown in FIG. 2A in order to perform computations on a column group matrix having a size of n×p. The systolic array 11 may, for example, receive an input row data_in having input values data_in[0] to data_in[4], and generate an output row having output values data_out[0] to data_out[4] according to the external control signal ext_en and the control signal op_in. As shown in FIG. 2A, the systolic array 11 has a square array structure, and has multiple operating cells 110A and 110B arranged in an array. In the following description, the systolic array 11 with a size of 5×5 is taken as an example to describe the operation process of the Gaussian elimination computing system 1. Those skilled in the art may adjust the size of the systolic array 11 adaptively according to different design requirements. More specifically, the systolic array 11 has first operating cells 110A and second operating cells 110B. The first operating cell 110A is arranged on the main diagonal of the systolic array 11 (i.e., the diagonal from the upper left to the lower right), and the second operating cell 110B is arranged on a position other than the main diagonal of the systolic array 11. Each operating cell 110 may be, for example, a circuit structure realized according to a Mealy state machine, which includes appropriate logic gates and flip-flops coupled to each other to realize its functions. Therefore, each time the operating cell 110 is triggered by the clock signal, it generates an output data value according to the received input data value and its own stored data value.

FIG. 2B and FIG. 2C are schematic diagrams of truth tables of the second operating cell 110B and the first operating cell 110A in FIG. 2A respectively. Specifically, the second operating cell 110B has relatively simpler logic functions compared with the first operating cell 110A, and each second operating cell 110B may be operated by a 2-bit control signal OP and has four functions, which are the functions of passing (PASS), adding (ADD), swapping (SWAP), and initiating (INIT). Specifically, when operating under the passing (PASS) function, the second operating cell 110B only transmits the input data to the output terminal, and the input data does not affect the data value stored inside the second operating cell 110B. When operating under the adding (ADD) function, the second operating cell 110B outputs the sum of the input data value and the stored data value, and the input data does not affect the data value stored inside the second operating cell 110B. When operating under the swapping (SWAP) function, the second operating cell 110B writes the input data value into the cell, and outputs the stored data value. When operating under the initiating (INIT) function, the second operating cell 110B writes the input data value into the cell, and outputs the data value 0. Compared to some implementations, the passing (PASS), adding (ADD), and swapping (SWAP) functions are instructed by two-bit control signals, while the initiating (INIT) function is indicated by an additional bit, and the control signal of the second operating cell 110B is coded in a relatively concise manner, so that the area of the Gaussian elimination computing system 1 may be effectively improved regardless of the signal routing or hardware structure requirements.

For the first operating cell 110A, the first operating cell 110A may be operated in the decomposition operation mode or the replay operation mode. As shown in FIG. 2C, when operating in the decomposition operation mode, the first operating cell 110A generates the output control signal OPA according to the received control signal op_in and the control of the external enable signal ext_en. When the external enable signal ext_en is, for example, a logic value of 1, the first operating cell 110A may be controlled by the control signal OP under the functions of passing (PASS), swapping (SWAP), and initiating (INIT), and respectively output control signals op_out corresponding to passing (PASS), swapping (SWAP), and initiating (INIT). In addition, when the external enable signal ext_en is, for example, a logic value of 0, the first operating cell 110A may operate under the functions of passing (PASS), swapping (SWAP), and adding (ADD) according to the input data value and its own stored data value. In addition, when the first operating cell 110A operates in the replay operation mode, the first operating cell 110A may have the same operating characteristics as the second operating cell 110B. Therefore, according to the truth table shown in FIG. 2B, it may operate under the functions of passing (PASS), adding (ADD), swapping (SWAP) and initiating (INIT) according to receiving an external control signal op_in.

Referring back to FIG. 2A, in terms of the overall operation of the systolic array 11, the values of each row in the column group matrix may be respectively input to each operating cell 110 in the first row of the systolic array 11 from above the systolic array 11. The first row of the systolic array 11 operates in a corresponding state according to the received external enable signal ext_en[0] and the control signal op_in[0] to perform computations and output data values to the second row of the systolic array 11. Similarly, the systolic array in the second row also performs computations according to the external enable signal ext_en[1] and the control signal op_in[1], and outputs data values to the systolic array 11 in the third row, and so on.

Although a systolic array 11 with a size of 5×5 is shown in FIG. 2A, the size of the systolic array 11 is not limited thereto, as long as the number of columns of the systolic array 11 is greater than or equal to the number of columns of the column group matrix.

FIG. 2B and FIG. 2C show and describe the truth tables of the first operating cell 110A and the second operating cell 110B, so as to describe the respective operations of the first operating cell 110A and the second operating cell 110B. However, as shown in FIG. 2A, in addition to the coupling relationship between rows and columns for all operating cells 110, the first operating cells 110A on the diagonal are also connected in series with each other, and such series connection relationship is used to configure the early-abortion function of the first operating cells 110A.

FIG. 2D is a circuit schematic diagram of the error detection circuit 1100 in the first operating cell 110A in FIG. 2A. In the systolic array 31, the error detection circuit 1100 of each first operating cell 110A is connected to the error detection circuit 1100 of the first operating cell 110A of the previous stage to receive the error detection judgment result fail_in of the first operating cell 110A of the previous stage. The received error detection judgment result fail_in is computed with the inverted internal storage data by an OR gate 1101, and is output after being selected by the multiplexer 1102 controlled by the control signal check_en. In addition, a flip-flop 1103 is coupled to the output terminal of the multiplexer 1102 to store the error detection judgment result fail_out, and output the error detection judgment result fail_out to the first operating cell 110A of the next stage according to the driving of the clock signal. Therefore, in actual operation, all the data stored in the first operating cell 110A are checked through the error detection circuit 1100 connected in series. As long as the data stored in any first operating cell 110A is 0, the error detection judgment result fail_out output by the first operating cell 110A of that stage is switched to logic value 1. The error detection judgment result fail_out with a logic value of 1 is continuously transmitted through the OR gate 1101 in the error detection circuit 1100 until the end of the list of the first operating cell 110A.

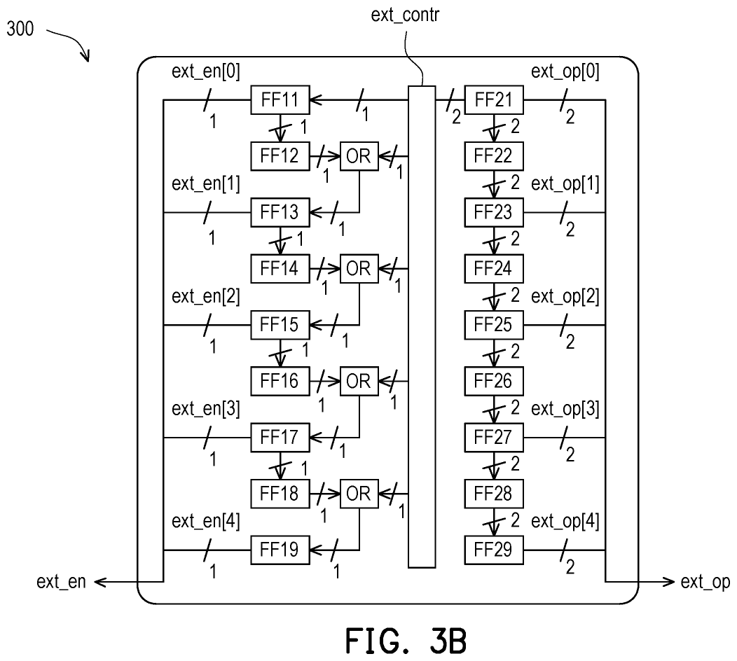

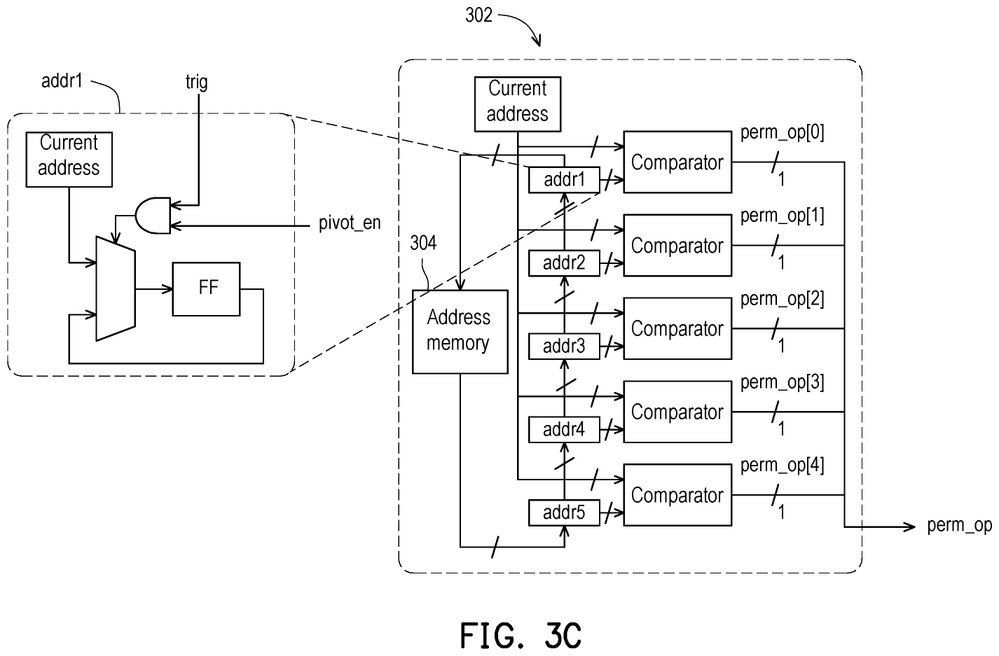

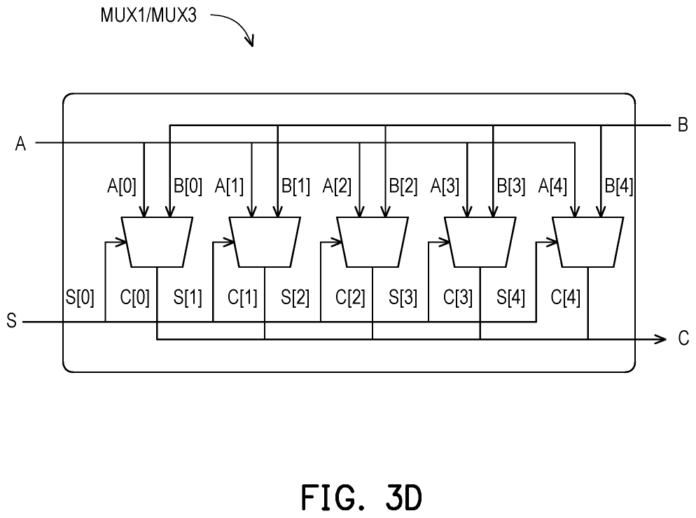

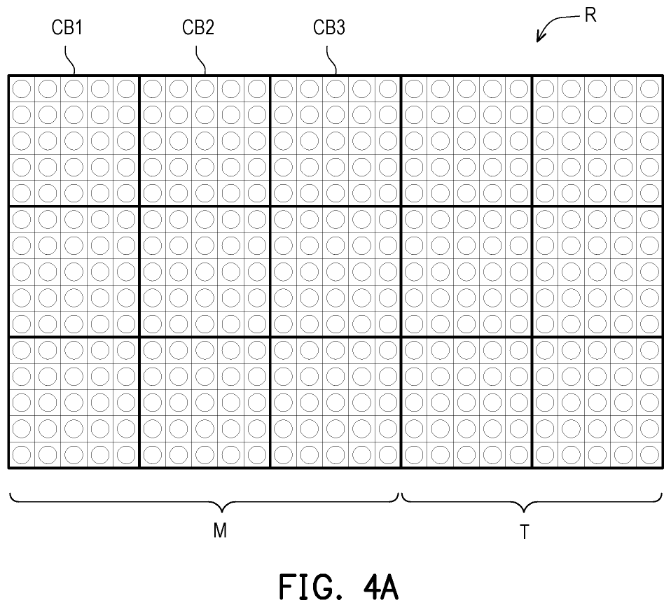

FIG. 3A is a block schematic diagram of a Gaussian elimination computing system 3 according to an embodiment of the disclosure. The Gaussian elimination computing system 3 includes a control circuit 30, a systolic array 31, and a memory 32. The Gaussian elimination computing system 3 is similar to the Gaussian elimination computing system 1, so for the structure and the respective operation details of the systolic array 31, please refer to the description of the systolic array 11 in FIG. 2A to FIG. 2D, and details are not repeated herein.

In detail, the control circuit 30 includes a first control circuit 300 and a second control circuit 301. The first control circuit 300 is used to generate an external enable signal ext_en and an external control signal ext_op. The second control circuit 301 may record the control signal op_out output by the systolic array 31 and generate the internal control signal int_op according to the systolic array 31. The control circuit 30 may select the external control signal ext_op or the internal control signal int_op according to the external enable signal ext_en through the selection of the multiplexer MUX2 to generate the control signal op_in. The control signal op_in selected by the multiplexer MUX2 is input to the systolic array 31 to control the operation of each row in the systolic array 31.

The second control circuit 301 includes a sorting circuit 302, a memory 303 and a multiplexer MUX1. The second control circuit 301 may use the sorting circuit 302 to store the sorting matrix P, which records the sequence relationship of each row when the systolic array 31 performs a matrix decomposition operation on the column group matrix. In addition, the second control circuit 301 may use the memory 303 and the multiplexer MUX1 to record the control signal op_out output by the systolic array 31, and generate the internal control signal int_op to the multiplexer MUX2. In some embodiments, the operation of the second control circuit 301 to update the memory 303 may be a partial update of the memory 303 according to a time sequence. In regards to the partially updated content, the circuit structure and the operational content are described in detail below.

In one embodiment, when the systolic array 31 is, for example, performing a decomposition operation of the column group matrix, the systolic array 31 may be operated under a triangular operation mode, that is, the second operating cell 110B below the diagonal of the systolic array 31 may be disabled or closed, and only the first operating cell 110A on the diagonal of the systolic array 31 and the second operating cell 110B above the diagonal are turned on to perform computations. In this triangular operation mode, the first operating cell 110A is operated under the decomposition operation mode, that is, the first operating cell 110A is operated according to the truth table shown in FIG. 2C, and the generated control signal is configured to control the turned on second operating cell 110B in the same row. Finally, the systolic array 31 outputs the control signal op_out from the first operating cell 110A on the diagonal.

In one embodiment, when the systolic array 31 is performing other operations, such as performing the replay operation, the systolic array 31 may be operated in a square array operation mode, that is, all operating cells 110 in the systolic array 31 are turned on for computation. In this square array operation mode, the first operating cell 110A is operated under the replay operation mode, that is, the first operating cell 110A operates according to the truth table shown in FIG. 2B, and the entire row of operating cells 110 in the systolic array 31 operates according to the received control signal op_in. Finally, the systolic array 31 may generate the output data signal data_out from the last row of operating cells 110 on the systolic array 31.

The multiplexer 33 is coupled to the systolic array 31 for receiving the output control signal op_out and the output data signal data_out. The multiplexer 33 selects the corresponding output according to whether the systolic array 31 operates in the triangular operation mode or the square array operation mode, and transmits it to the memory 32. The multiplexer 34 is coupled to the second control circuit 301. The multiplexer 34 is configured to receive the control signal op_out and the input row data_in read by the memory 32, and writes the operation result of the systolic array 31 or the data stored in the memory 32 into the memory 303 of the second control circuit 303 according to the computing requirements.

The output of the systolic array 31 is selected by the multiplexer MUX3 and written into the memory 32. The structure and function of the multiplexer MUX3 is similar to that of the multiplexer MUX1, and the multiplexer MUX3 may write a portion of the data by bit.

FIG. 3B is a circuit block diagram of the first control circuit 300 in FIG. 3A. FIG. 3C is a circuit block diagram of the sorting circuit 302 in FIG. 3A. FIG. 3D is a circuit block diagram of the multiplexers MUX1 and MUX3 in FIG. 3A. The structure and operation of FIG. 3B, FIG. 3C, and FIG. 3D are described in conjunction with the operation of the overall Gaussian elimination computing system 3 below.

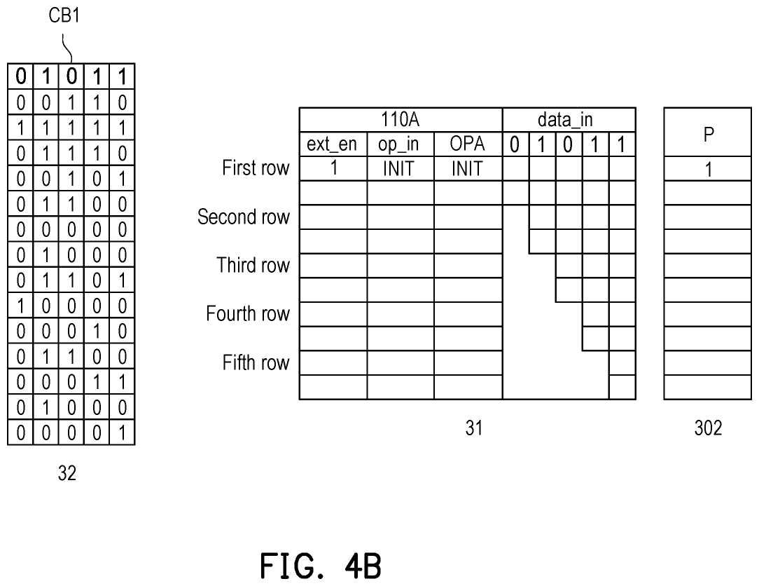

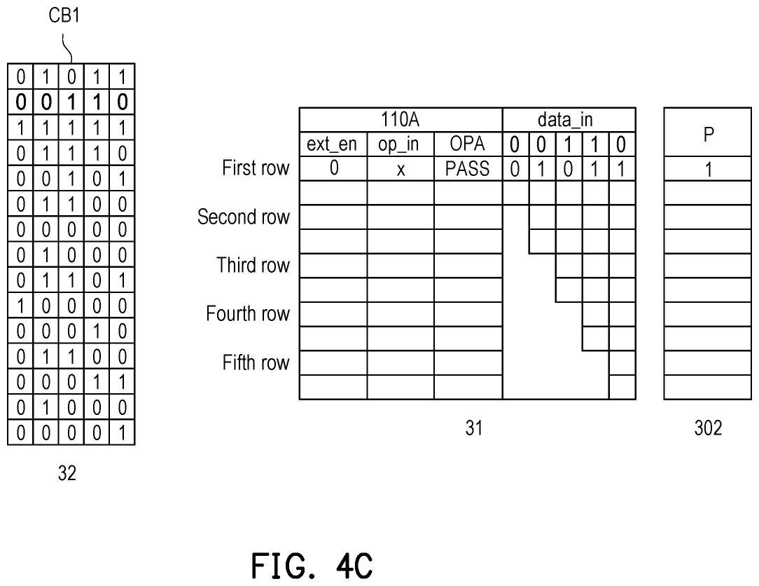

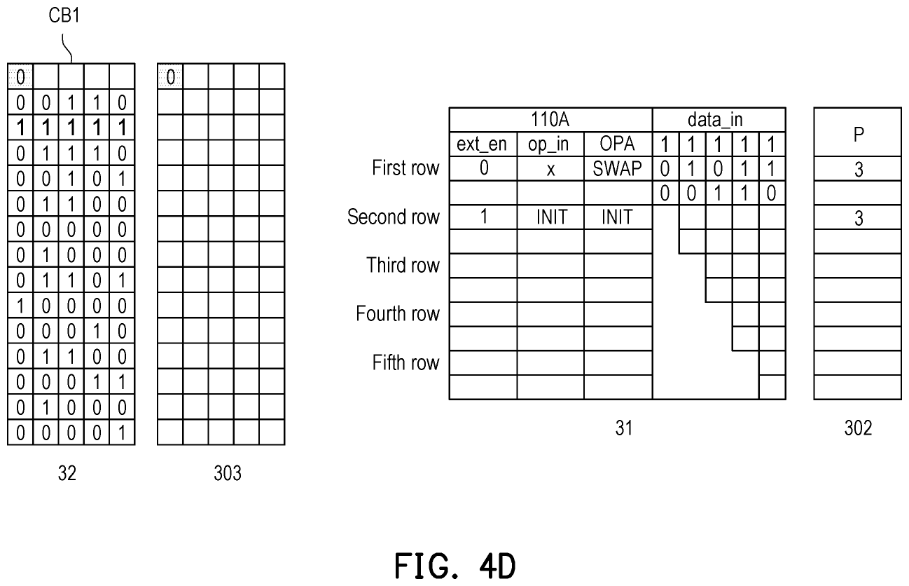

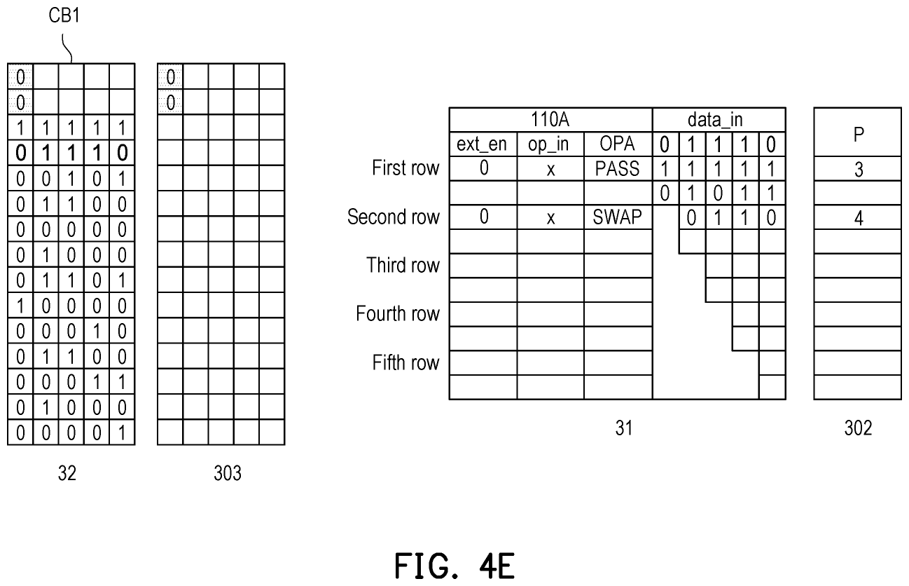

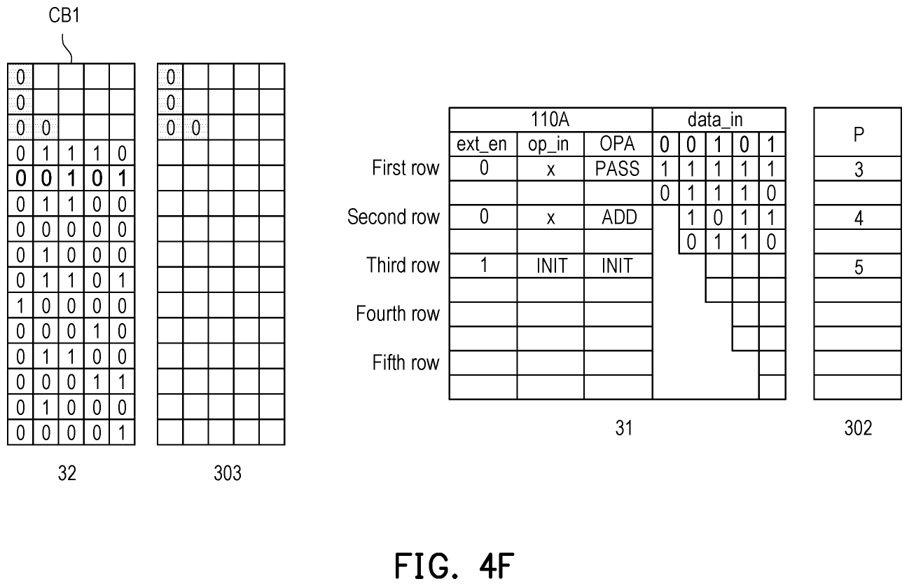

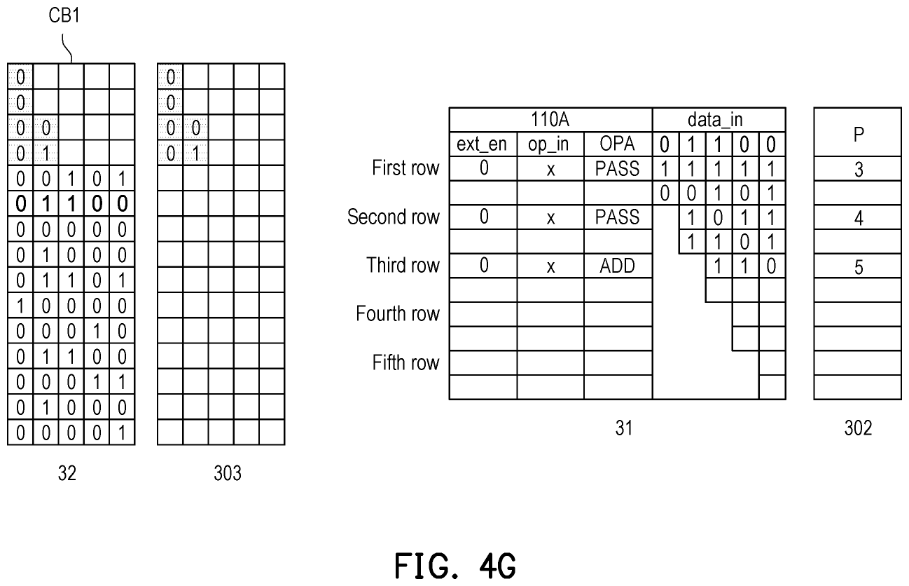

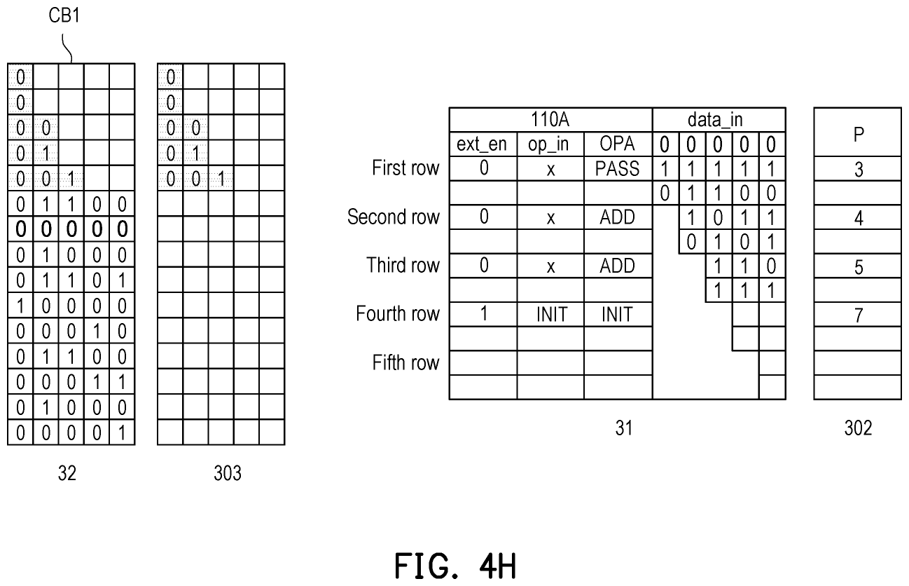

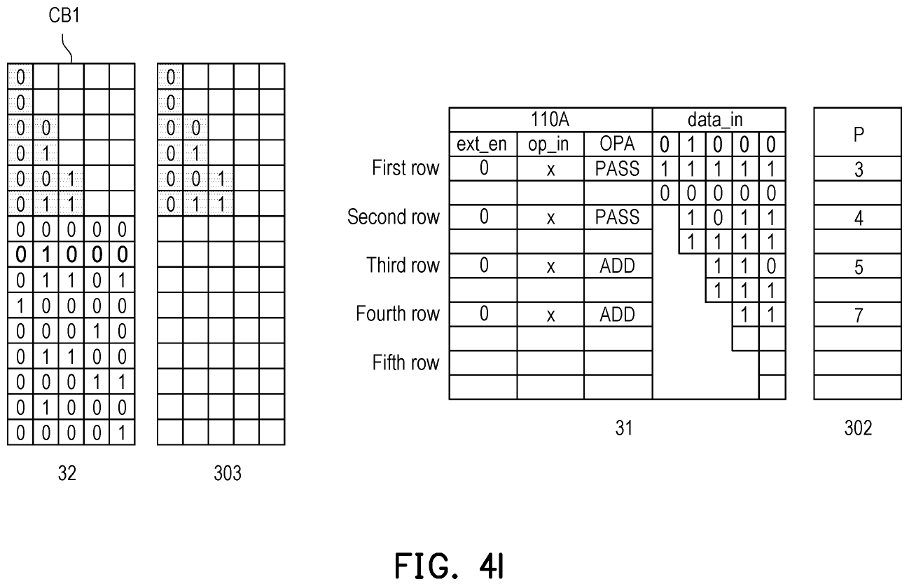

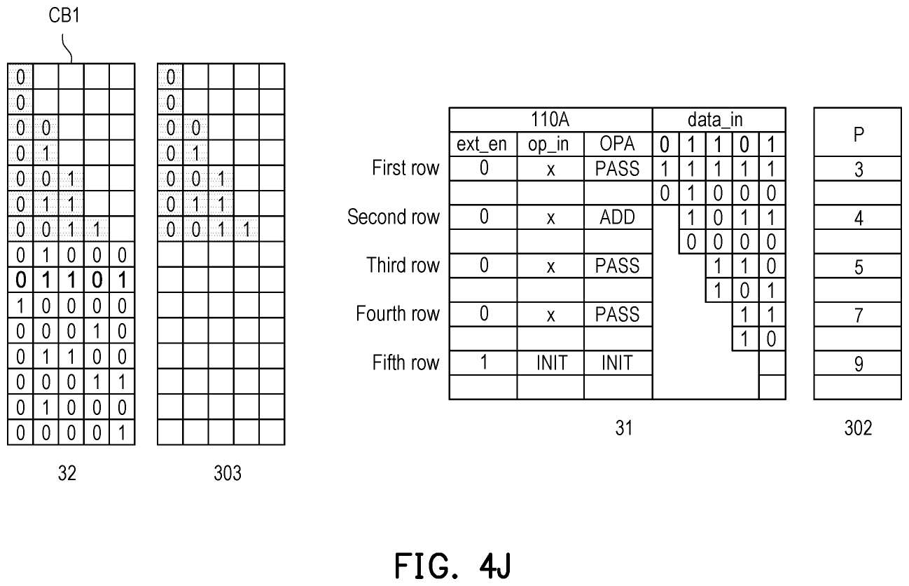

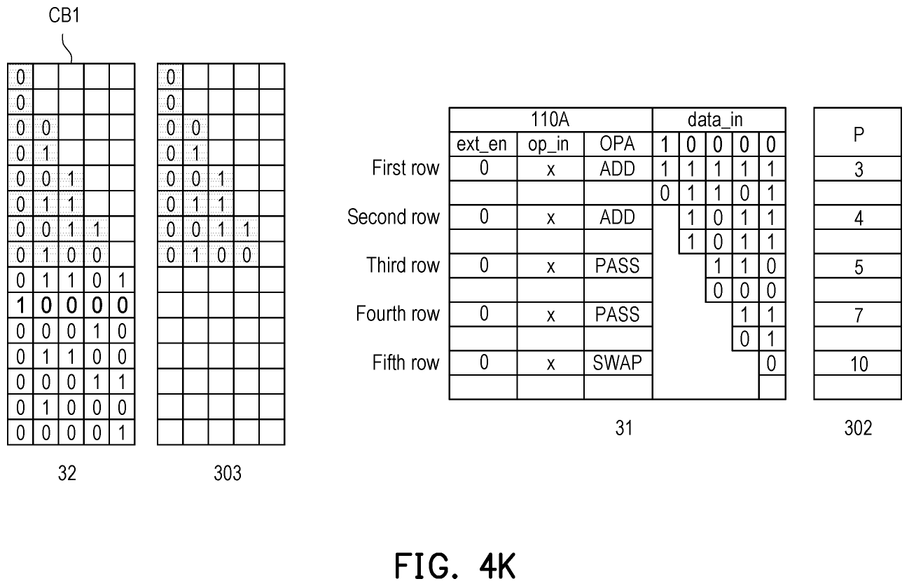

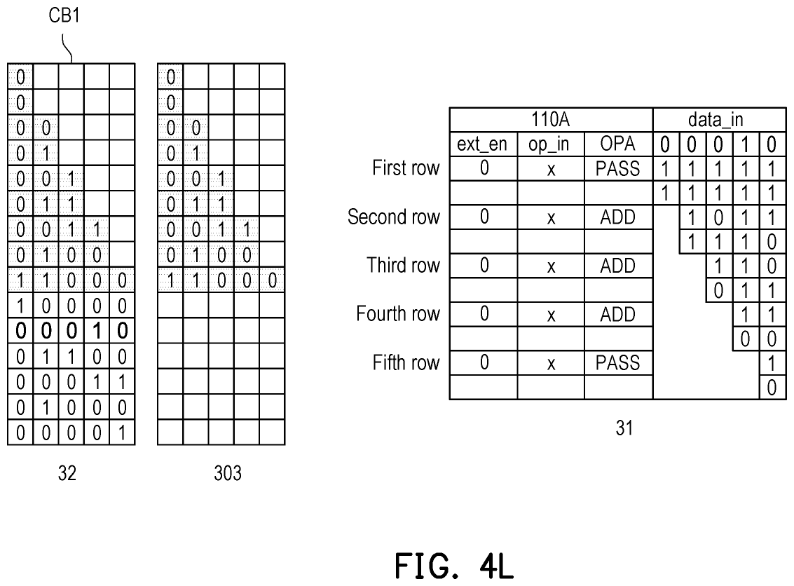

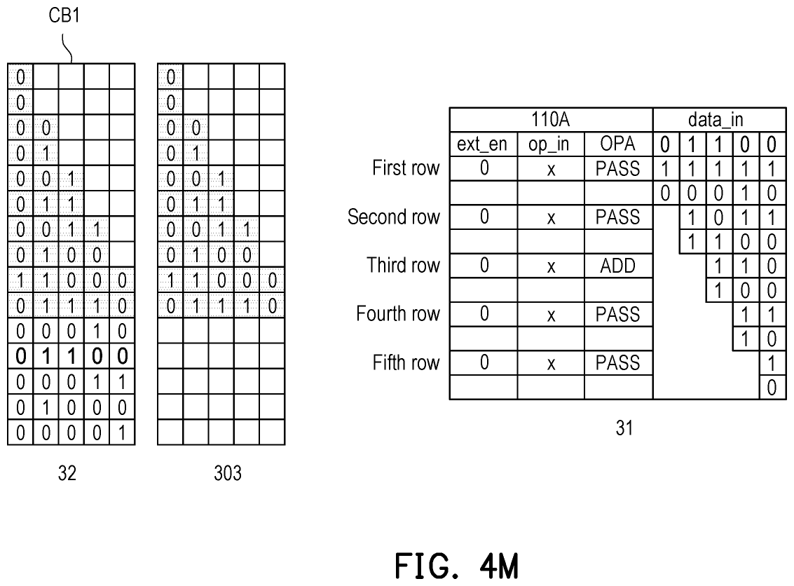

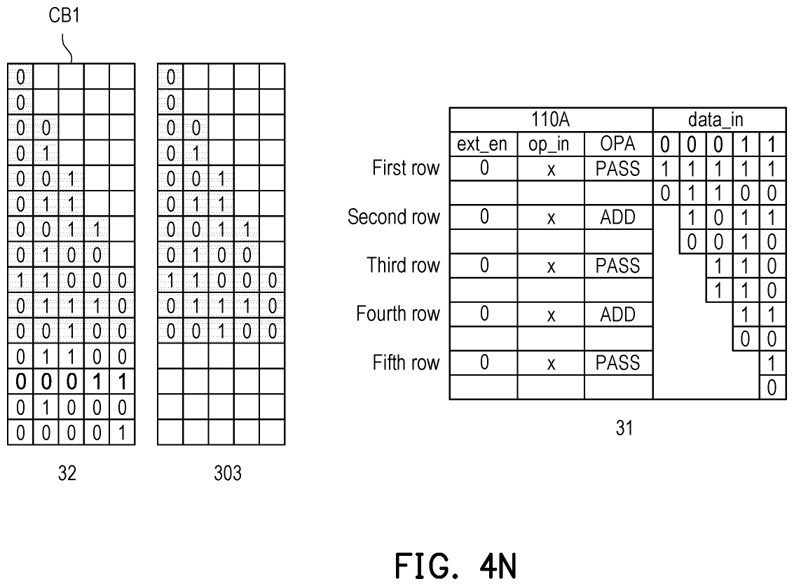

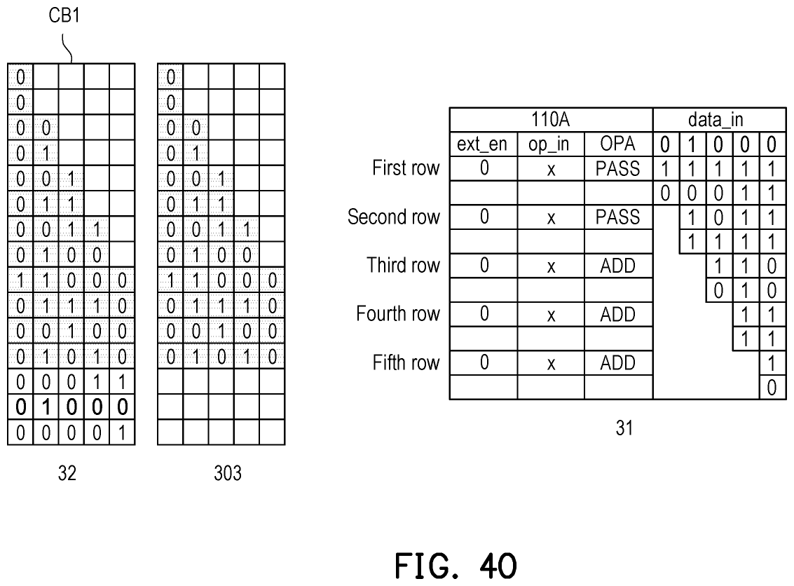

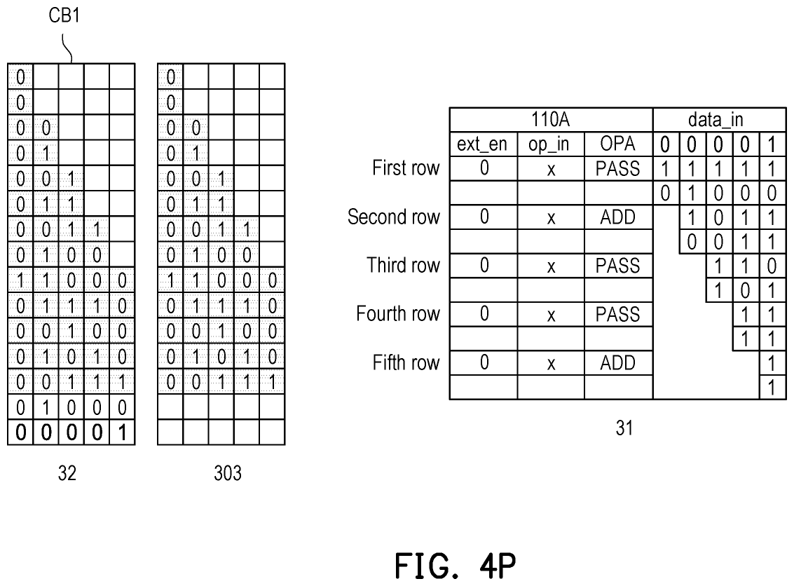

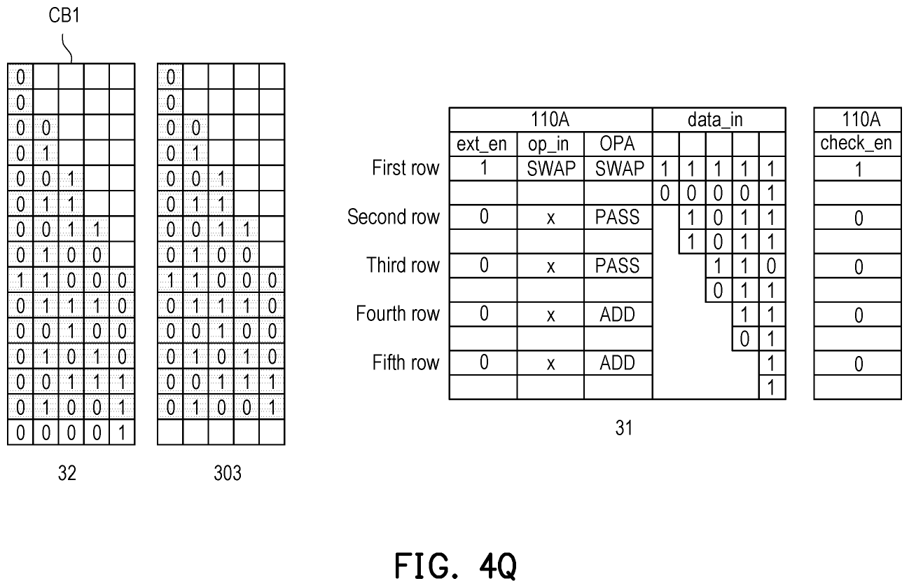

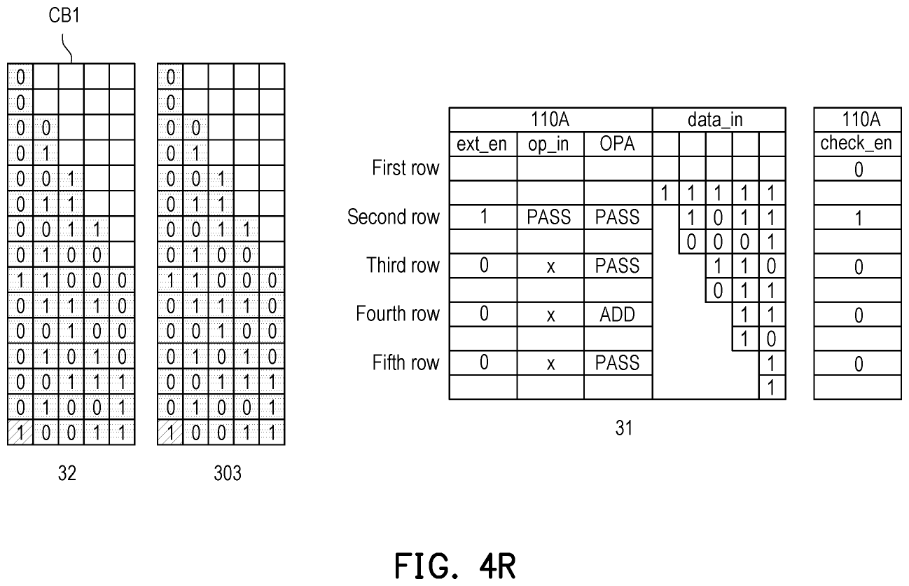

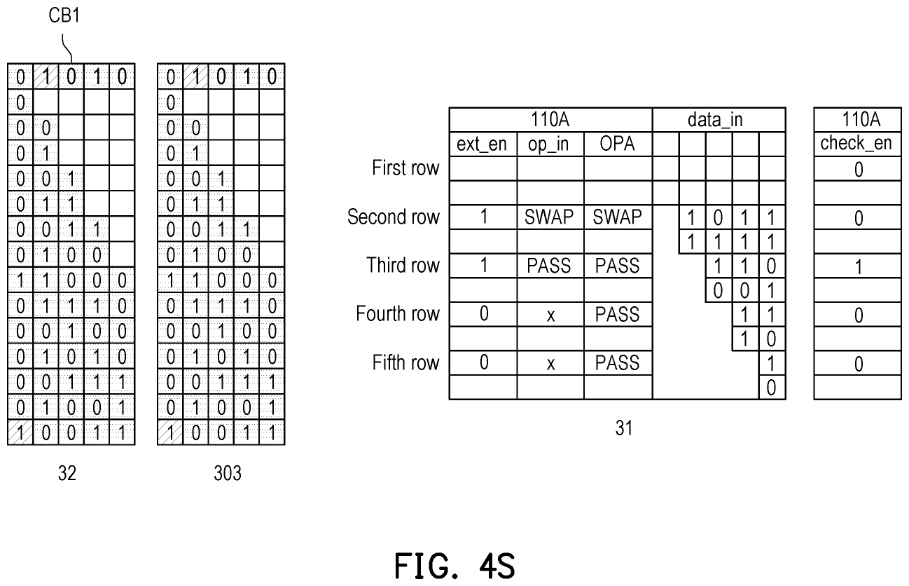

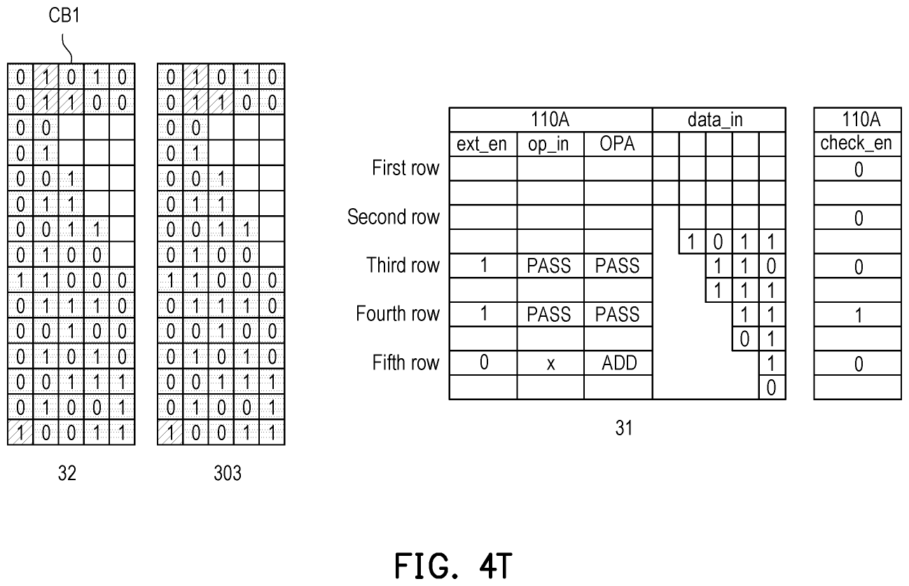

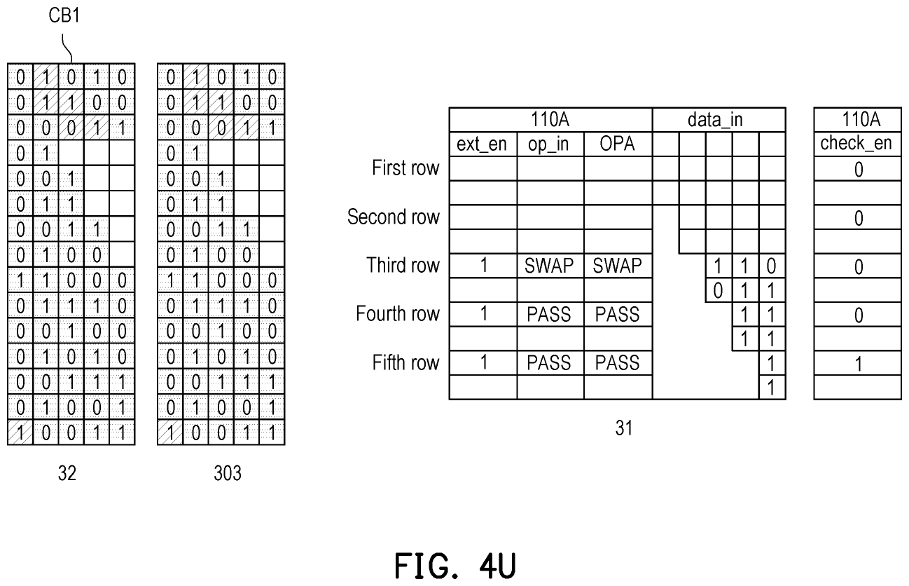

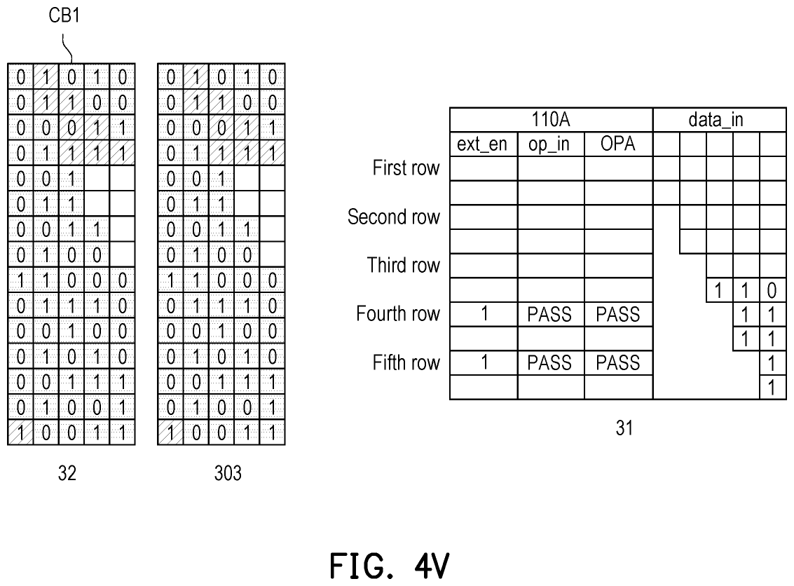

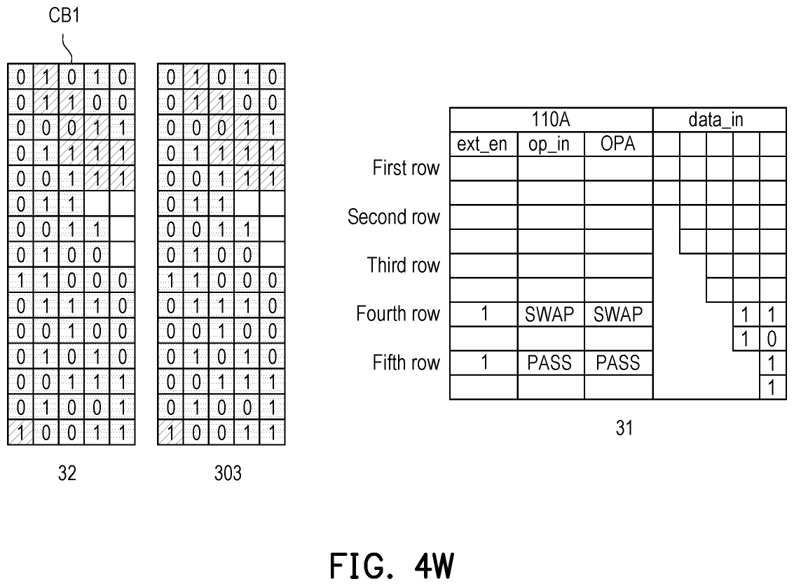

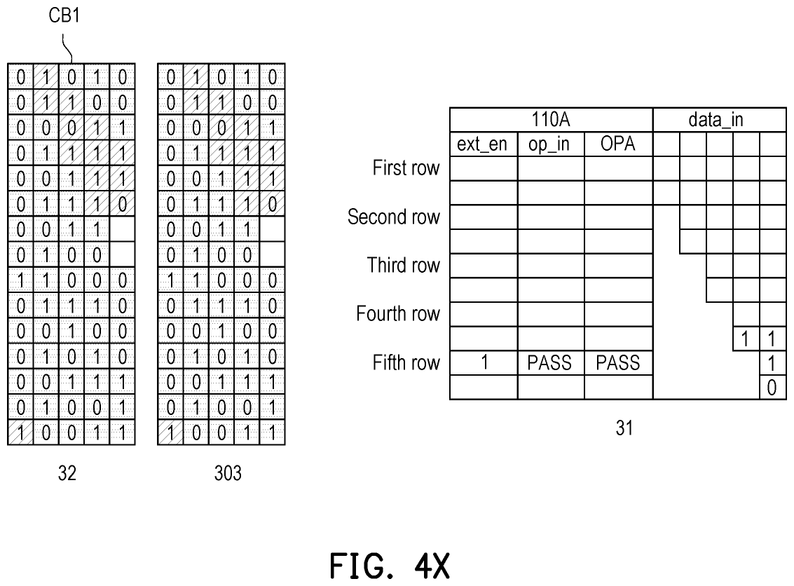

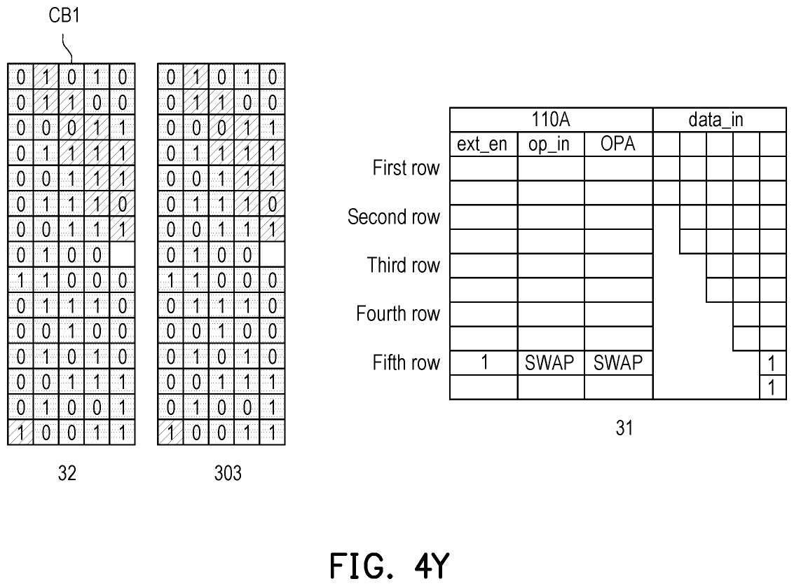

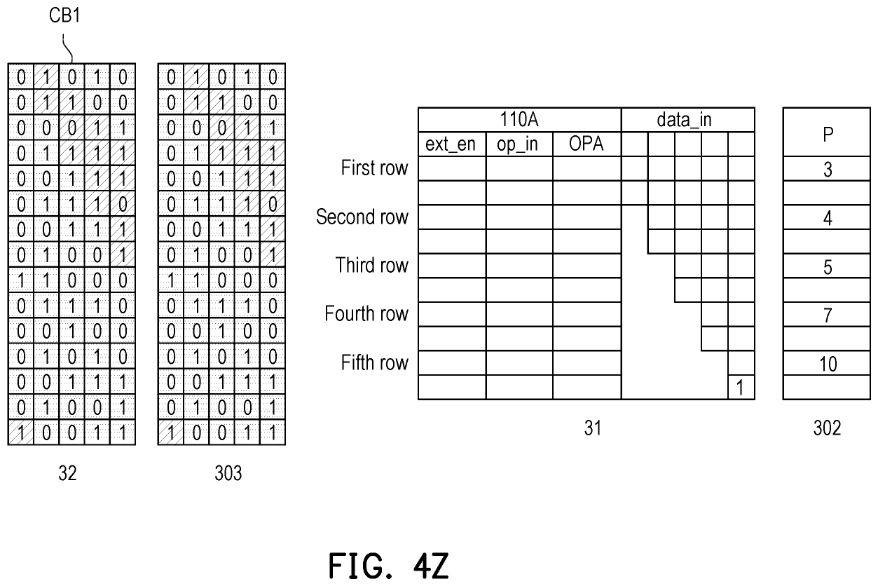

FIG. 4A to FIG. 4Z are the operation procedures of a systolic array 31 performing a matrix decomposition operation on the first column group matrix CB1. In FIG. 4A, the input matrix R with a size of 15×25 is firstly input to the control circuit 30 and stored in the memory 32. In order to perform a matrix decomposition operation and compute the public key matrix PK, the control circuit 30 first decomposes the input matrix R into a 15×15 operation matrix M and a 15×10 target matrix T. In FIG. 4A, for simplicity of of the figures, all the matrix units in the input matrix R are represented by circles ◯, but in practical applications, the matrix units in the input matrix R may have the same or different values.

Referring to FIG. 3B, FIG. 3B shows a circuit block diagram of the first control circuit 300 in FIG. 3A. The first control circuit 300 may generate an external enable signal ext_en and an external control signal ext_op according to operation requirements. In this embodiment, the first control circuit 300 may be configured to control, for example, a systolic array 31 with a size of 5×5. On the left side of FIG. 3B, the shift registers FF11 to FF19 connected in series delay the enable signal provided by the controller ext_contr, so that the output of each stage of the shift registers FF11 to FF19 has a delay of two clock cycles. In addition, the controller ext_contr may also switch the external enable signal provided to any row of the systolic array 31 to “enable” through an OR gate in a proper clock cycle.

On the other hand, on the right side of FIG. 3B, the shift registers FF21 to FF29 connected in series are also shown for providing the control signal ext_op to the systolic array 31. Similarly, the shift registers FF21 to FF29 delay the control signal provided by the external control signal ext_op, so that the output of each stage of the shift registers FF21 to FF29 has a delay of two clock cycles.

In FIG. 4B, the control circuit 30 divides the operation matrix M into multiple column group matrices. In this embodiment, the 15×15 operation matrix M is equally divided into three 5×15 column group matrices, and the first column group matrix is firstly provided to the systolic array 31 for operation. More specifically, the values of each row in the first column group matrix are provided to the first row of the systolic array 31 according to the time sequence, so that each row of the systolic array 31 performs operations in sequence and transmits the operation results to the next row of the systolic array 31. In addition, the systolic array 31 performing the matrix decomposition operation is controlled to operate in a triangular operation mode, that is, only the first operating cells 110A on the diagonal and the second operating cells 110B above the diagonal are turned on, while the second operating cells 110B below the diagonal are turned off.

In detail, the left side of FIG. 4B shows the first column group matrix in the operation matrix M, that is, the first column to the fifth column of the operation matrix M. The middle of FIG. 4B shows the values received, stored, and output by the operating cells 110 of each row of the systolic array 31. In FIG. 4B, the values [0 1 0 1 1] of the first row of the first column group matrix is firstly respectively input into each operating cell 110 in the first row of the systolic array 31. At this time, the external enable signal ext_en corresponding to the first row of operating cells 110 is enabled, so that the first row of operating cells 110 receives the externally provided control signal op_in. Therefore, the first row of operating cells 110 is controlled by the external control signal op_in to be under the initiating function.

Since the first row of operating cells 110 are controlled under the initiating function, referring to the truth tables of FIG. 2B and FIG. 2C, it may be seen that when the operating cells 110A and 110B are operated under the initiating function, the operating cells 110A and 110B store the input value inside the cells and output a logic value of 0.

In addition, the right side of FIG. 4B is the recording process of the sorting matrix. In this embodiment, the sorting matrix is a 1×15 matrix, respectively corresponding to the sorting or swapping results of the diagonal units in the first to fifteenth rows of the operation matrix M. In detail, when performing a matrix decomposition operation, such as a PLU decomposition operation, each row of the operation matrix M is appropriately swapped, so that the diagonal of the operation matrix M is full rank, that is, the cells on the diagonal in the operation matrix M are all value 1. Since the first column group matrix of the operation matrix M includes the diagonal units from the first row to the fifth row of the operation matrix M. Therefore, when performing the operation of the first column group matrix, only the sorting results of the first to fifth rows of the operation matrix M are recorded, in which the results are recorded in the sorting matrix. In this embodiment, in response to the external enable signal ext_en whose logic value is switched to 1, it means that when the operating cells 110 in the first row receive input values and perform operations in the first clock cycle, the sorting matrix is pre-written with an address of 1 in the unit corresponding to the first row, which means that the operating cell 110 of the first row in the systolic array 31 is recording the value of the first row of the first column group matrix.

In FIG. 4C, the external enable signal ext_en provided to the first row of the systolic array 31 is set to logic value 0, so that the operating cells 110 of the first row of the systolic array 31 perform operations according to the input value and the stored value. More specifically, the first operating cell 110A of the first row in the systolic array 31 generates the control signal op_out according to the input value and the stored value, and the control signal generated is provided to the remaining second operating cells 110B which are turned on in the first row.

In this embodiment, the value [0 0 1 1 0] of the second row in the first column group is provided to the operating cell 110 of the first row in the systolic array 31. The first operating cell 110A in the first row determines that the operating cell 110A in the row performs the passing (PASS) function according to the received logic value 0 and the stored logic value 0. Therefore, the received logic value 0 serves as the control signal op_out corresponding to the passing (PASS) function, and a control signal OPA corresponding to passing (PASS) is provided to the remaining second operating cells 110B in the same row. Therefore, the operating cells 110 of the first row directly input the received value [0 0 1 1 0] to the operating cells 110 of the second row in the next clock cycle.

In FIG. 4D, the value [1 1 1 1 1] of the third row in the first column group is provided to the operating cells 110 of the first row in the systolic array 31. At the same time, the operating cells 110 in the second row receive the output value of the row of operating cells 110 (i.e., the value [0 0 1 1 0] of the second row in the first column group). For the first operating cell 110A of the first row in the systolic array 31, the stored value is 0 and a value of 1 is received, thus generating a control signal OPA corresponding to swapping (SWAP), thereby controlling other second operating cells 110B in the same row to perform row swapping in the next clock cycle. That is to say, in the next clock cycle, the operating cells 110 of the first row swaps the received third row in the first column group with the stored first row in the first column group. Therefore, the operating cells 110 of the first row store the value of the third row in the first column group matrix in the next clock cycle, and output the originally stored value in the first row of the first column group matrix to the operating cell 110 in the second row.

In response to the swapping decision generated by the operating cell 110 of the first row in this cycle, the value 3 is stored in the first unit of the sorting matrix, meaning that the value of the third row in the first column group is stored in the operating cell 110 of the first row. Meanwhile, since the operating cell 110 of the second row also receives the external enable signal ext_en with a logic value of 1, the cycle number 3 is also recorded in the corresponding second unit of the sorting matrix.

In detail, regarding the recording process of the sorting matrix P, please refer to the sorting circuit 302 shown in FIG. 3C. The sorting circuit 302 includes a ring structure in which the address recorders addr1 to addr5 and the address memory 304 are connected in series. Specifically, the address recorders addr1 to addr5 respectively correspond to the five rows of the systolic array 31. When the systolic array 31 starts to perform the matrix decomposition operation each time, the address memory 304 may firstly respectively write the addresses stored therein into the address recorders addr1 to addr5. Then, during the subsequent matrix decomposition operation, when any row of the systolic array 31 is initiated (INIT) or swapped (SWAP), it causes the first operating cell 110A of the row to send an enabling trigger signal trig to the corresponding address recorder, and write the current address into the flip-flop FF when the enable signal pivot_en is also enabled, to complete the recording of the addresses of each row. In some embodiments, the current address is the count of the current clock cycle. Multiple comparators are respectively coupled to the address recorders addr1 to addr5 for generating control signals perm_op[0] to perm_op[4]. The comparators compare the current address with the address stored in the address recorder. When the comparators determine that the current address reaches the address recorded by the address recorder, the comparators output an enabling control signal to control the corresponding row in the operation array 31 to perform swapping (SWAP).

Finally, the value computed and output by the first operating cell 110A in each cycle is recorded in the internal memory of the control circuit 30 and the memory 32 is updated at the same time. Specifically, in this clock cycle, the internal memory of the control circuit 30 and the first row of the memory 32 are updated. Since only the first operating cell 110A of the first row outputs a logic value of 0 in this clock cycle, in both the internal memory of the control circuit 30 and the memory 32, only the first unit of the first row is written with a logic value of 0.

In FIG. 4E, in this clock cycle, the first operating cell 110A in the first row generates the control signal op_out corresponding to swapping (SWAP). The operating cell 110 in the second row stores the last four units [0 1 1 0] of the second row in the column group matrix after being initiated, and simultaneously receives the value [0 1 0 1 1] of the first row of the column group matrix. Therefore, the first operating cell 110A in the second row generates the control signal op_out that corresponds to swapping (SWAP), and updates the sorting matrix accordingly. Finally, the logic value 0 output by the first operating cell 110A of the first row, that is, the control signal op_out corresponding to passing (PASS) is recorded in the internal memory of the control circuit 30 and the first unit of the second row in the memory 32.

In FIG. 4F, the first operating cells 110A in the first row to the third row of the systolic array 31 respectively determine to perform the functions of passing (PASS), adding (ADD), and initiating (INIT). What is described here is the operation of the first operating cell 110A of the second row in the systolic array 31, which generates the judgment result that the row should perform the addition (ADD) function. Therefore, in the next clock cycle, the operating cells 110 of the row sum up the received value and the stored value and then output the sum. But in actuality, the first operating cell 110A in the row outputs the received logic value 1 as the control signal op_out corresponding to the adding (ADD) function.

Generally speaking, in the following FIG. 4F to FIG. 4P, the data values of the fifth row to the last row in the column group matrix are input into the first row of the systolic array 31 in time sequence. The rows of the systolic array 31 are computed according to the received data after initiating, and the values output by the systolic array 31 are sequentially written into the internal memory of the control circuit 30 and the third row to the third last row in the memory 32.

In addition, the first operating cells 110A in the third row to the fifth row of the systolic array 31 respectively store the data value 1 in the clock cycle of FIG. 4F, FIG. 4H, and FIG. 4K, so the sorting matrix respectively records the values of 5, 7, and 10 in the third to fifth units.

In FIG. 4Q, after all row data values of the column group matrix are input to the systolic array 31, the enabled external enable signal ext_en is provided to the first row of the systolic array 31, and the control signal op_in corresponding to the swapping (SWAP) function is also input externally. Therefore, the first row of the systolic array 31 releases its stored row data value and passes it to the next row of the systolic array 31. Moreover, in the cycle of the following FIG. 4R to FIG. 4Z, by providing an appropriate external enable signal ext_en and a control signal op_in of the corresponding function, the operating cells 110 of each row may release their stored values row by row.

In addition, in FIG. 4Q to FIG. 4U, the control signal check_en is sequentially provided to the first operating cells 110A in each row. Referring to FIG. 2D, the sequentially enabled control signal check_en causes the first operating cells 110A of each row to check whether their stored value is 1 stage by stage. In this embodiment, when the value stored in a first operating cell 110A is 0, the first operating cell 110A generates a termination signal to terminate the computation of the input matrix R currently received by the Gaussian elimination computing system 3, realizing early-abortion and requesting to update the input matrix R to compute the public key based on the next input matrix R. Therefore, it is only when the values stored in all the first operating cells 110A are non-zero that the control circuit 30 of the Gaussian elimination computing system 3 performs the computation of the next column group matrix, thereby avoiding waste of invalid computation time.

On the other hand, please refer to FIG. 4R and FIG. 4S. When the systolic array 31 completes the writing of the last row of the internal memory of the control circuit 30 and the last row of the memory 32, compared with configuring a larger memory block to continue to store the next sequence of row data generated by the systolic array 31, the Gaussian elimination computing system 3 uses the unused memory blocks in the upper half of the internal memory of the control circuit 30 and the memory 32. That is, the upper right triangular block in the internal memory of the control circuit 30 and the storage space of the memory 32 are used to store the following output value of the systolic array 31. In other words, when the systolic array 31 completes the writing of the last row of the internal memory of the control circuit 30 and the last row of the memory 32, the systolic array 31 loops back to the first row of the internal memory of the control circuit 30 and the first row of the memory 32, and aligns the terminal of the first row for writing, so as to write the generated operation result into the unused upper right triangular block in the internal memory of the control circuit 30 and the storage space of the memory 32.

Referring to FIG. 3A and FIG. 3D, in order to write the operation results into the unused upper right triangular block in the internal memory of the control circuit 30 and the storage space of the memory 32, the operation results generated by the systolic array 31 are respectively written into the memory 303 and the memory 32 through the multiplexers MUX1 and MUX3. Specifically, the multiplexers MUX1 and MUX3 may receive two sets of inputs A and B, and the multiplexers MUX1 and MUX3 may perform bit-by-bit selection through the selection signal S. For example, in the clock cycle shown in FIG. 4S, the selection signal S may select the first bit of input A to pass through and the second to fifth bits of input B to pass through, thus the combined output C is written to the memory 303 and the memory 32.

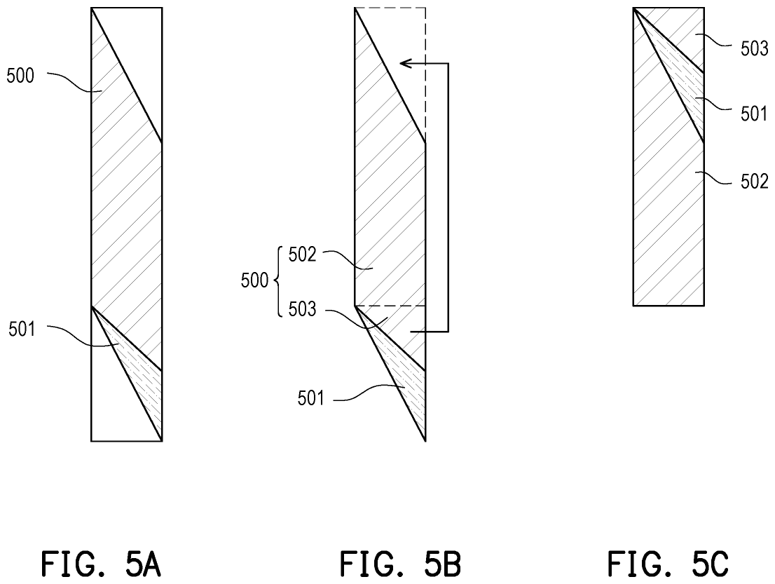

Finally, the matrix decomposition result of the first column group matrix is as shown in FIG. 4Z. In addition, please refer to FIG. 5A to FIG. 5C to understand how the systolic array 31 configures the operation results into the memory 32. FIG. 5A to FIG. 5C are schematic diagrams of how the systolic array 31 in FIG. 3A writes to the memory 32. In detail, as shown in FIG. 5A, since the operating cells 110A in the first row to the fifth row in the systolic array 31 are turned on and off according to the row sequence during the matrix decomposition operation, that is, the first operating cell 110A in the first row is turned on first and the computation is completed at the earliest, whereas the first operating cell 110A in the fifth row is the last to be turned on and the computation is the last to be completed. Therefore, the operation results of each row output by the first operating cell 110A in the systolic array 31 are arranged according to the output time sequence to form a parallelogram as shown in FIG. 5A. In detail, the horizontal axis direction in FIG. 5A to FIG. 5C represent the output values of each first operating cell 110A of the first row to the fifth row of the systolic array 31, and the vertical axis direction represent the time sequence when each first operating cell 110A of the systolic array 31 generates an output value.

As shown in FIG. 5A, the operation result generated by the systolic array 31 includes data blocks 500 and 501. The data block 500 is the lower triangular matrix generated during the PLU decomposition, and the data block 501 is the upper triangular matrix generated during the PLU decomposition. In the data block 500, since the systolic array 31 receives each row of the column group matrix according to the row sequence, the operation results recorded in the data block 500 are also arranged in the row sequence of the column group matrix. In addition, in the writing time sequence of the data block 501 (please refer to FIG. 4R to FIG. 4Z), taking the row data value stored in the first row of the systolic array 31 as an example, the first row of data values stored in the systolic array 31 is the first to be output. As shown in FIG. 4R and FIG. 4S, when the second row of the operating cells 110 of the systolic array 31 receives the unit value of the first row of the upper triangular matrix U output by the first row of the operating cells 110 of the systolic array 31, the second row of the operating cells 110 of the systolic array 31 performs passing (PASS) first and then outputs the unit values in the second row of the upper triangular matrix U by swapping (SWAP). Therefore, in the data block 501, that is, the operation results recorded in the upper triangular matrix U are also arranged in the row sequence of the first column group matrix CB1.

If the operation results generated by the systolic array 31 in each clock cycle are respectively stored in a single row of data blocks, as shown in FIG. 5A, the memory 32 needs to use a larger memory space than the input column group matrix for storage, causing a burden on the hardware. As shown in FIG. 5B, in this embodiment, in order to save memory space, the memory 32 is configured with a memory space of the same size as the column group matrix to store the operation result of the systolic array 31. After the systolic array 31 completes writing to the last row of the memory 32, the systolic array 31 loops back to the first row of the memory 32 for writing. More precisely, when looping back to the first row of the memory 32 for writing, the systolic array 31 aligns the terminal of each row of the memory 32 for writing, so as to write the operation result into the unused space at the terminal of the row of the memory 32, thus effectively saving the memory space required by the Gaussian elimination computing system 3. From the configuration of the data space, the data block 500 is divided into two data blocks 502 and 503, in which the data block 502 and the column group matrix have the same row number. The data block 503 of the lower half triangular portion of the data block 500 and the data block 501 are filled on the top of the data block 502, thus generating a rectangular operation result configuration result as shown in FIG. 5C.

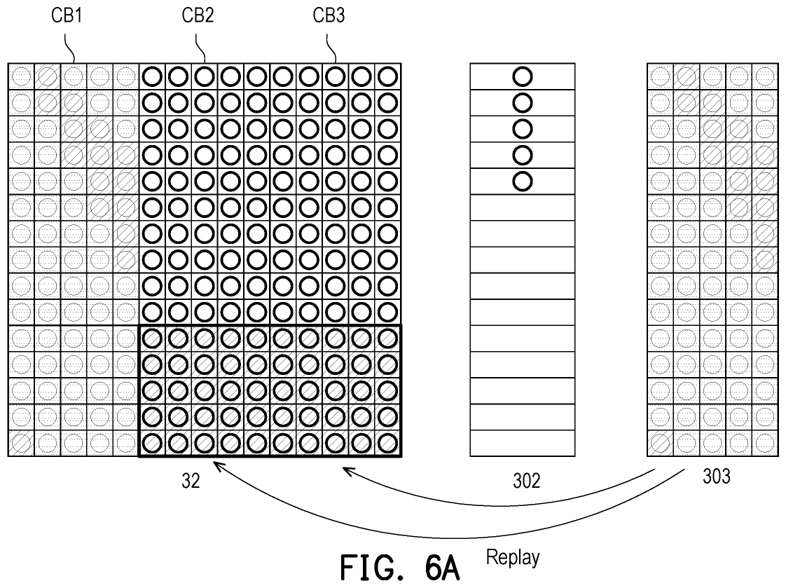

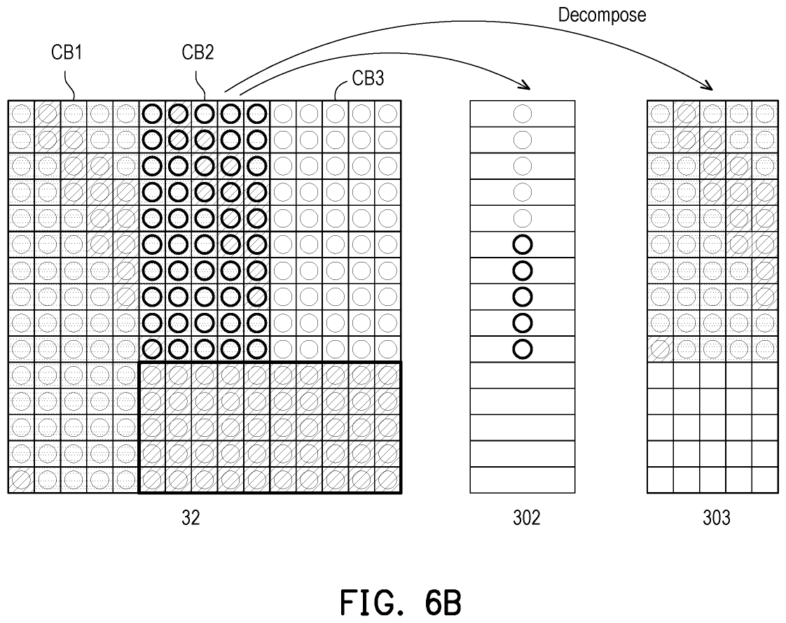

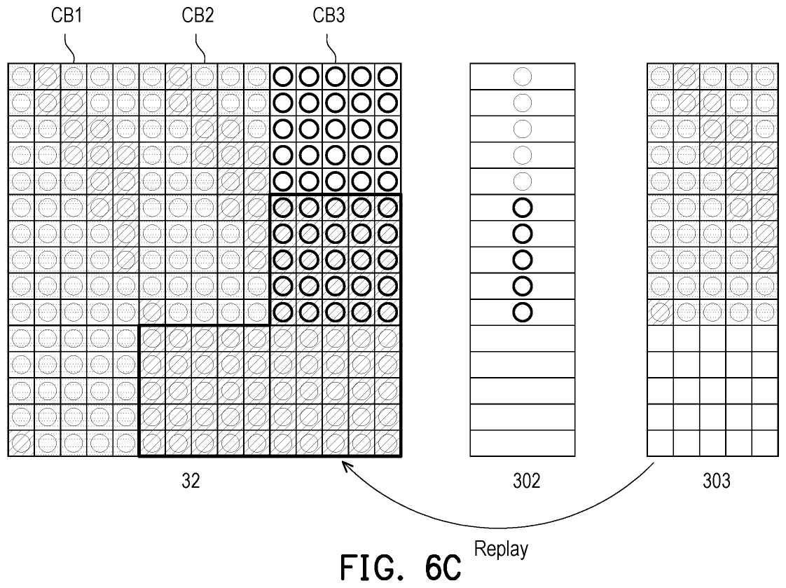

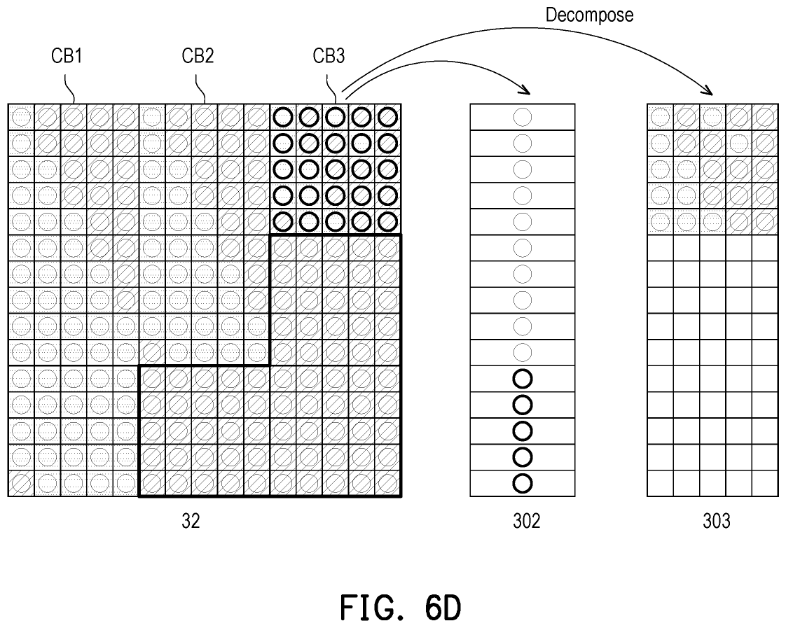

FIG. 6A to FIG. 6D are schematic diagrams of performing a matrix decomposition operation process to an operation matrix M. In FIG. 6A to FIG. 6D, the data stored in the memory 32, the sorting circuit 302 of the control circuit 30, and the memory 303 are shown. More specifically, the memory 32 stores the decomposing operation matrix M, and the sorting circuit 302 stores the sorting matrix P.

In FIG. 6A, following FIG. 4Z, the first column group matrix CB1 of the operation matrix M has been decomposed and written into the memory 32 and the memory 303 of the control circuit 30. Since the matrix decomposition operation is an operation performed in units of rows, the Gaussian elimination computing system 3 then replays the operation of the first column group matrix on the second column group and the third column group, and then performs the matrix decomposition operation of the second column group.

In detail, when the replay operation is performed, all operating cells 110 of the systolic array 31 are turned on, and the first operating cell 110A is also switched to the replay operation mode. In this way, all the operating cells 110 will operate according to the externally provided control signal op_in.

The second column group matrix may be input to the systolic array 31, and the memory 303 of the control circuit 31 stores the control signal op_out generated when the first column group matrix performs the matrix decomposition operation, which represents the operation behavior of each row of the first column group matrix when the matrix decomposition operation is performed. Therefore, by sequentially inputting the row data of each row of the second column group matrix to the systolic array 31, and respectively providing the control signal op_out of each row stored in the memory 303 to the corresponding row of the systolic array 31, the operation of the first column group matrix during matrix decomposition may be replayed on the second column group. More specifically, in the first clock cycle, the first row of the second column group matrix may be input to the systolic array 31 as the input row data_in, and the first unit value of the first row of the control signal op_out stored in the memory 303 is also provided to the first row of the systolic array 31 as the control signal op_in. In the second clock cycle, the second row of the second column group matrix may be input to the systolic array 31 as the input row data_in, and the first unit value of the second row of the control signal op_out stored in the memory 303 is also provided to the first row of the systolic array 31 as the control signal op_in. In the third clock cycle, the third row of the second column group matrix may be input to the systolic array 31 as the input row data_in, and the first and second unit values of the second row of the control signal op_out stored in the memory 303 is also provided to the first and second row of the systolic array 31 as the control signal op_in. In this way, the systolic array 31 receives the same control signal op_in as the first column group matrix when performing the matrix decomposition operation, thus replaying the operation of the first column group matrix on the second column group matrix. By analogy, in the following clock cycle, each row of the second column group matrix is provided to the systolic array 31 in sequence, and the memory 303 of the second control circuit 301 provides the control signal op_in to each row of the systolic array 31 in the form of a parallelogram as shown in FIG. 5A.

On one hand, each unit of the control signal op_in records a one-bit logic value, and a logic value of 0 corresponds to, for example, a passing (PASS) function, while a logic value of 1 corresponds to, for example, an adding (ADD) function. On the other hand, the sorting circuit 302 may refer to the first five units of the stored sorting matrix P to instruct to perform a swapping (SWAP) operation. More specifically, the values recorded in the first five units in the sorting matrix P correspond to the clock sequences when the first to fifth rows of the systolic array 31 are swapped (SWAP). According to this, the sorting circuit 302 may control each row in the systolic array 31 to perform the swapping operation in the corresponding clock cycle. For example, when the first five units in the sorting matrix P record the value of [3 4 5 7 10], the sorting circuit 302 may accordingly control the first to fifth rows of operating cells 110 in the systolic array 31 to perform row swapping in the third, fourth, fifth, seventh and tenth clock cycles.

By observing FIG. 5A, it may be seen that since the control signals op_in provided to the systolic array 31 are sorted according to the time axis, they have the characteristics of a parallelogram. This represents that when the systolic array 31 performs the operation of the first column group CB1 in the beginning, the operating cells 110 in the first row initiates operation, while the operating cells 110 in the second to fifth rows are initiated sequentially in subsequent operations. Towards the end of the operation, the operating cells 110 of the first row complete the operation first, and the operating cells 110 in the second to fifth rows complete the operation sequentially in subsequent operations. In some embodiments, the replay operations of the second column group and the third column group may be input to the systolic array 31 in such a way that the column groups partially overlap. For example, when the replay operation of the second column group CB2 is at the terminal, that is, when the first row of the operating cells 110 in the systolic array 31 have completed operations but the second to fifth rows of the operating cells 110 in the systolic array 31 are still performing operations, the value of the first row of the third column group CB3 may continue to be input into the first row of the operating cells 110 of the systolic array 31, so that the first row of the operating cells 110 of the systolic array 31 may perform the replay operation of the third column group CB3. In this way, the systolic array 31 may utilize the complementary characteristics of the control signal op_in at the beginning and end of the replay operation, such that the systolic array 31 simultaneously performs the replay operation at the end of the second column group and the replay operation at the beginning of the third column group in a portion of the clock cycle. Therefore, the scheduling of the operation of the systolic array 31 may be more compact without waste of operation resources and time.

Therefore, as shown in FIG. 6A, after the replay operation of the second column group and the third column group is completed, the selected pivot row in the first column group is moved to the bottom five rows of the second column group and the third column group, and the operation results of the remaining rows are arranged on top. Next, the Gaussian elimination computing system 3 performs a matrix decomposition operation on the second column group.

FIG. 6B is the matrix decomposition result of the second column group. During the matrix decomposition process of the second column group, the rows above the pivot row in the second column group are sequentially input to the systolic array 31 operating under the triangular operation mode to generate the decomposition result of the second column group, and the sorting of the sixth to tenth pivot rows is recorded in the sixth to tenth units of the sorting matrix.

In FIG. 6C, the third column group matrix is replayed according to the matrix decomposition result of the second column group matrix. More specifically, the first ten rows of the third column group matrix is input to the systolic array 31 operating under the square array operation mode to perform the replay operation according to the decomposed second column group matrix and the sixth to tenth units in the sorting matrix. Therefore, the pivot row selected by decomposing the second column group is moved to the sixth to tenth rows.

Finally, in FIG. 6D, the third column group matrix performs the matrix decomposition operation. During the matrix decomposition process of the third column group, the first to fifth rows above the pivot row in the third column group are sequentially input to the systolic array 31 operating under the triangular operation mode to generate the decomposition result of the third column group, and the sorting of the eleventh to fifteenth pivot rows is recorded in the eleventh to fifteenth units of the sorting matrix.

After computing the sorting matrix P, the lower triangular matrix L, and the upper triangular matrix U, as shown in the previous Formula (3), the computation process of multiplying the inverse matrix L⁻¹ of the lower triangular matrix L and the sorting matrix P by the target matrix T is performed.

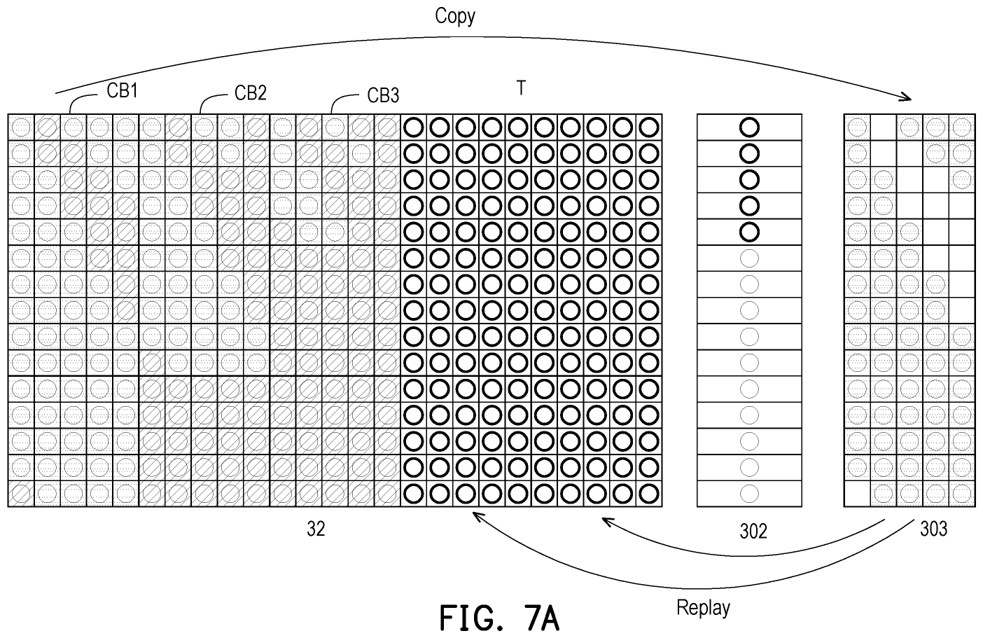

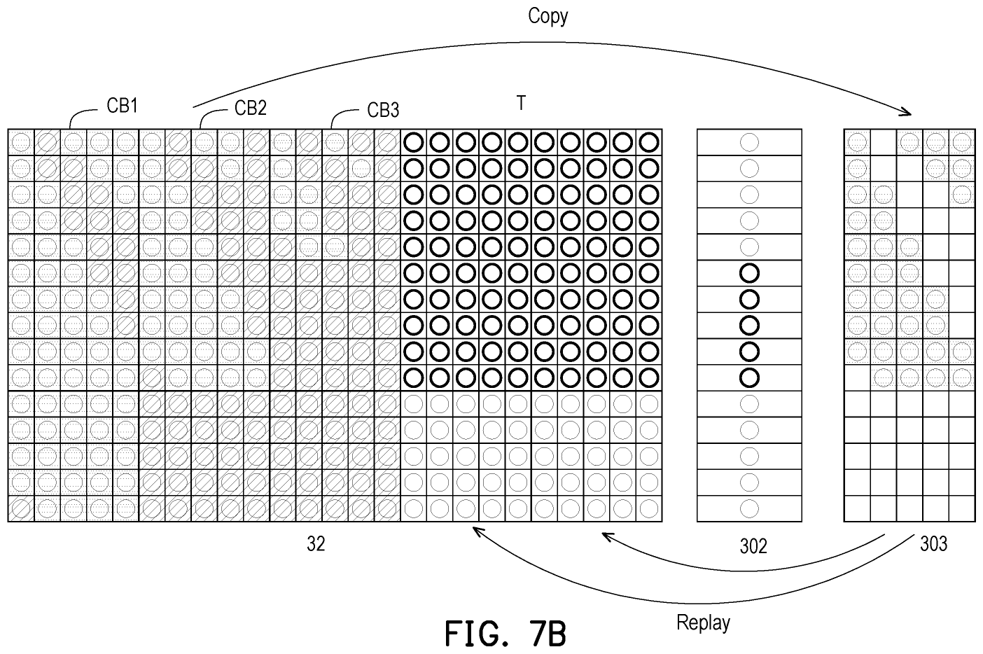

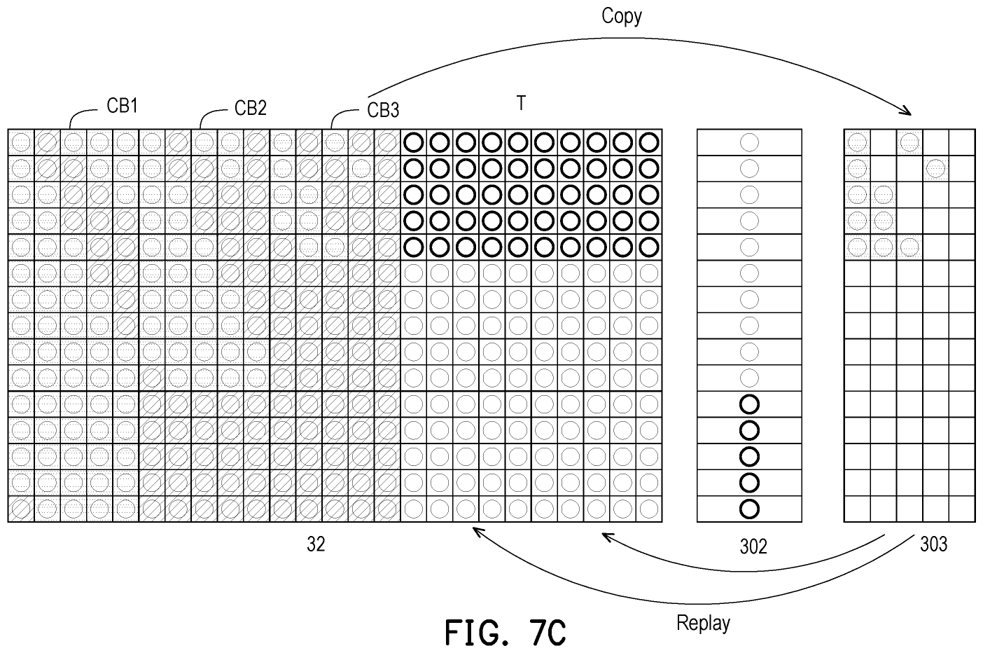

FIG. 7A to FIG. 7C are schematic diagrams of the computing process of how to multiply the inverse matrix L⁻¹ of the lower triangular matrix L and the sorting matrix P by the target matrix T.

As shown in FIG. 7A, the lower triangular matrix portion of the first column group matrix CB1 stored in the memory 32 is selected by the multiplexer 34 and then copied to the memory 303 first, and then the replay operation is performed on the target matrix T in cooperation with the first five units of the sorting matrix P. Similarly, in FIG. 7B, the second column group matrix CB2 and the sixth to tenth units of the sorting matrix are configured to perform the replay operation on the target matrix T. The operation is proceeded in FIG. 7C, the last third column group matrix CB3 and the eleventh to fifteenth units of the sorting matrix are configured to perform the replay operation on the target matrix T. After completing the operations of FIG. 7A to FIG. 7C, the computation process of (L⁻¹·P·T) in the above Formula (3) is completed.

Next, the Gaussian elimination computing system 3 performs a replay operation on the target matrix T according to the inverse matrix U⁻¹ of the upper triangular matrix U, so as to compute the computing process of U⁻¹·(L⁻¹·P·T). In detail, please refer to the following Formula (4) for the relationship between the upper triangular matrix U and the inverse matrix U⁻¹.

$$U = [ \begin{matrix}1 & U 12 & U 13 & U 14 & U 15 \\ 0 & 1 & U 23 & U 24 & U 25 \\ 0 & 0 & 1 & U 34 & U 35 \\ 0 & 0 & 0 & 1 & U 45 \\ 0 & 0 & 0 & 0 & 1\end{matrix} ] \qquad ( 4 )$$

$${U}^{- 1} = [ \begin{matrix}1 & U 12 & 0 & 0 & 0 \\ 0 & 1 & 0 & 0 & 0 \\ 0 & 0 & 1 & 0 & 0 \\ 0 & 0 & 0 & 1 & 0 \\ 0 & 0 & 0 & 0 & 1\end{matrix} ] … [ \begin{matrix}1 & 0 & 0 & U 14 & 0 \\ 0 & 1 & 0 & U 24 & 0 \\ 0 & 0 & 1 & U 34 & 0 \\ 0 & 0 & 0 & 1 & 0 \\ 0 & 0 & 0 & 0 & 1\end{matrix} ] \cdot [ \begin{matrix}1 & 0 & 0 & 0 & U 15 \\ 0 & 1 & 0 & 0 & U 25 \\ 0 & 0 & 1 & 0 & U 35 \\ 0 & 0 & 0 & 1 & U 45 \\ 0 & 0 & 0 & 0 & 1\end{matrix} ]$$

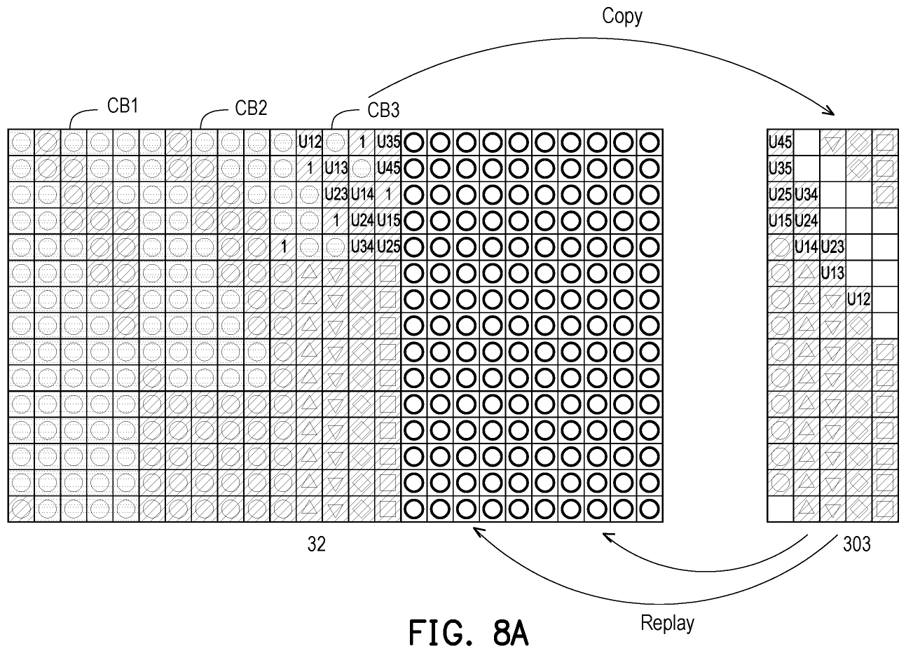

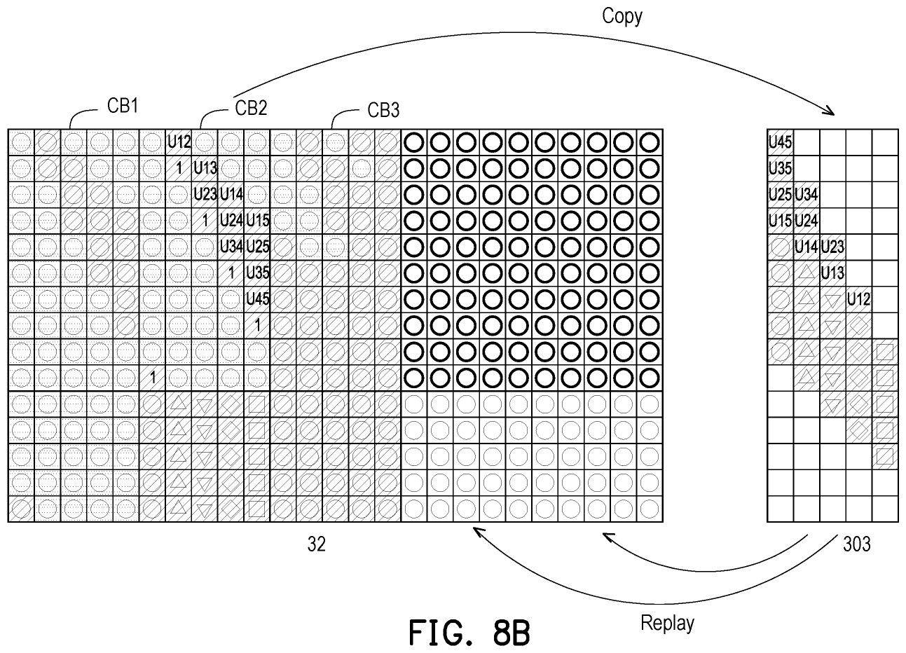

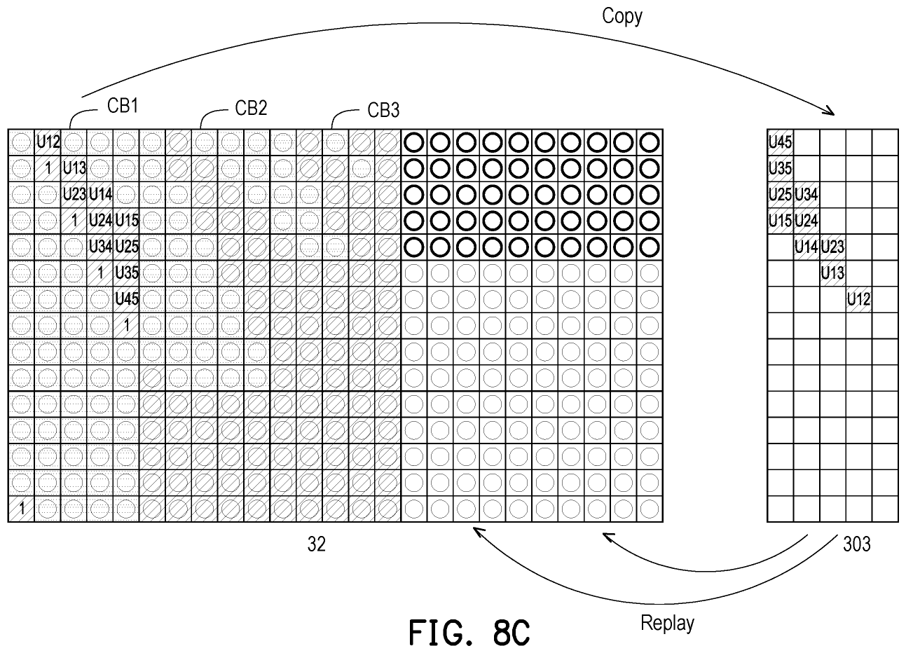

According to the above Formula (4), when performing the multiplication of the inverse matrix U⁻¹, it may be equivalent to using the unit value of the upper triangular matrix U, in which the computation of the unit value of the last column of the upper triangular matrix U must be performed before the second-to-last column, and the computation of the unit value of the second-to-last column must be performed before the third-to-last column, and so on. Therefore, in order to realize the computation sequence derived from the above Formula (4), the control circuit 30 may write the values in the upper triangular matrix U into the memory 303 in the second control circuit 301 through the method and sequence shown in FIG. 8A to FIG. 8C, thereby realizing the multiplication of the inverse matrix U⁻¹.

FIG. 8A to FIG. 8C are schematic diagrams of how to perform computation according to the inverse matrix U⁻¹ of the upper triangular matrix U to obtain the public key matrix PK.

As shown in FIG. 8A, the inversion process of the upper triangular matrix U is performed on the upper right third column group matrix CB3 first as shown in the figure. In the first to the fifth row of the third column group matrix CB3, the unit labeled with a value of 1 is the diagonal unit generated after decomposition, so in the inversion process of the upper triangular matrix U, only the units U12 to U15, U23 to U25, U34 to U35, and U45 are inversed, and are stored in the memory 303 according to the position correspondence shown in FIG. 8A. In addition, the portion of the sixth to fifteenth rows below the third column group matrix, without adjusting the arrangement sequence, continues after the units U12 to U15, U23 to U25, U34 to U35, and U45 that have been adjusted above, thus generating the result shown on the right side of FIG. 8A. Specifically, the sixth to fifteenth rows below the third column group matrix may be input to the systolic array 31 operating in the triangular operation mode, and through the first control circuit 300, appropriate external enable signal ext_en and control signal ext_op are provided to the systolic array 31, so that the systolic array 31 operates under the shift buffer mode and generates the arrangement relationship as shown in FIG. 8A. Compared with using additional shift registers to arrange the sixth to fifteenth rows below the third column group matrix, the same effect may be achieved by switching the systolic array 31 that is operating in the triangular operation mode to operating in the shift buffer mode, thereby effectively reducing the hardware requirements and cost of the Gaussian elimination computing system 1. Finally, the inverse matrix U⁻¹ of the upper triangular matrix U stored in the memory 303 is configured to perform the replay operation. Furthermore, in FIG. 8B and FIG. 8C, the second column group matrix and the first column group matrix are sequentially inversed and then configured to perform the replay operation. After completing the operations of FIG. 8A to FIG. 8C, the entirety of the computation process of U⁻¹·(L⁻¹·P·T) in the above Formula (3) is completed, thereby the public key matrix PK is computed.

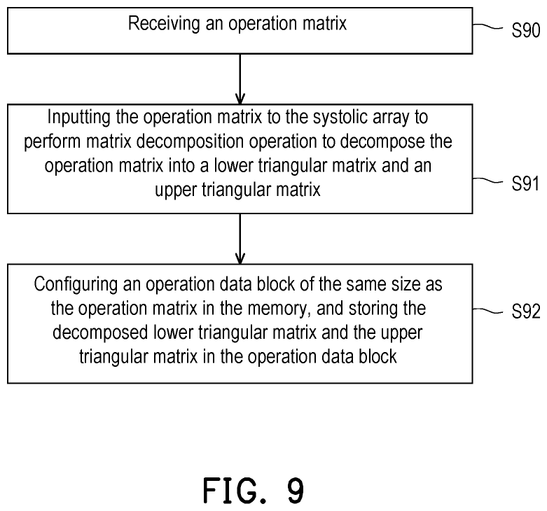

FIG. 9 is a flowchart of a Gaussian elimination computing method according to an embodiment of the disclosure. The Gaussian elimination computing method includes steps S90 to S92. The Gaussian elimination computing method may be applied to the Gaussian elimination computing system 1 of FIG. 1 and/or the Gaussian elimination computing system 3 of FIG. 3. In step S90, the operation matrix is input to the Gaussian elimination computing system. In step S91, the operation matrix is input to the systolic array in the Gaussian elimination computing system for matrix decomposition operation, so as to decompose the operation matrix into a lower triangular matrix and an upper triangular matrix. In step S92, an operation data block with the same size as the operation matrix is configured in the memory of the Gaussian elimination computing system, and the decomposed lower triangular matrix and upper triangular matrix are stored in the operation data block. For the detailed operation content of the Gaussian elimination computing method, please refer to the operation instructions of the Gaussian elimination computing system 1 and 3 above.

To sum up, the Gaussian elimination computing method and Gaussian elimination computing system of the disclosure may efficiently utilize memory space, save invalid computing time, and effectively improve the efficiency and hardware requirements of public key computing.

What is claimed is:

1. A Gaussian elimination computing system, comprising:
a control circuit, receiving an operation matrix;
a systolic array, comprising a square array formed by a plurality of operating cells, wherein the systolic array is configured to perform a matrix decomposition operation to the operation matrix to decompose the operation matrix into a lower triangular matrix and an upper triangular matrix; and
a memory, configured with an operation data block with the same size as the operation matrix for storing the lower triangular matrix and the upper triangular matrix after decomposition.

2. The Gaussian elimination computing system according to claim 1, wherein the control circuit equally divides the operation matrix into a plurality of column group matrices, which respectively have the same number of rows as the operation matrix, and the control circuit respectively inputs each of the column group matrices to the systolic array to perform the matrix decomposition operation.

3. The Gaussian elimination computing system according to claim 2, wherein the control circuit provides a plurality of rows of each of the column group matrices to a first row of the systolic array according to a row sequence,
each of the rows of the systolic array receives an input row matrix from a previous row, and an operation is performed to generate an output row matrix, which is passed to a following row of each of the rows.

4. The Gaussian elimination computing system according to claim 3, wherein the operating cells comprises:
a plurality of first operating cells, arranged on a diagonal in the systolic array; and
a plurality of second operating cells arranged at positions other than the diagonal in the systolic array, wherein
when the systolic array operates in a triangular operation mode, the first operating cells are operated under a decomposition operation mode, the second operating cells arranged below the diagonal are turned off, each of the first operating cells generates a control signal according to a received first data value and a stored second data value, so as to control the second operating cells in the same row to perform the same operation as the first operating cell;
when the systolic array operates in a square array operation mode, all of the operating cells are turned on and the first operating cells are operated under a replay operation mode, and the operating cells of each of the rows jointly receive a control signal to perform the same operation.

5. The Gaussian elimination computing system according to claim 4, wherein an operation performed by the operating cells comprises one of shifting, adding, swapping, and initiating.

6. The Gaussian elimination computing system according to claim 4, wherein each of the first operating cells respectively checks whether each of the stored second data values is zero after completing an operation on each of the column group matrices.

7. The Gaussian elimination computing system according to claim 6, wherein the control circuit terminates the operation of the input matrix and requests to update the input matrix when any one of the second data values is checked to be zero.

8. The Gaussian elimination computing system according to claim 2, wherein the systolic array is written in a first row of the memory in a manner of aligning row heads in the memory when the systolic array writes an operation result of each of the column group matrices into the memory, and the systolic array loops back to a first row of the memory and performs subsequent writes in a manner of aligning row terminals in the memory after the systolic array completes writing a last row of the memory according to a row sequence.

9. The Gaussian elimination computing system according to claim 8, further comprising a multiplexer, coupled between the systolic array and the memory, wherein the multiplexer is configured to receive a selection signal to selectively write an operation result of each of the column group matrices into the memory by bit.

10. The Gaussian elimination computing system according to claim 1, wherein the control circuit receives an input matrix, and obtains the operation matrix and a target matrix by dividing the input matrix, wherein the input matrix, the operation matrix, and the target matrix have the same number of rows,
wherein the control circuit further records a sorting matrix to record a sorting of all rows of the operation matrix in the matrix decomposition operation, the control circuit controls the systolic array to compute the target matrix according to the sorting matrix, the upper triangular matrix, and the lower triangular matrix to obtain a public key matrix.

11. A Gaussian elimination computing method, comprising:
receiving an operation matrix;
inputting the operation matrix into a systolic array to perform a matrix decomposition operation, and decomposing the operation matrix into a lower triangular matrix and an upper triangular matrix; and
configuring a memory with an operation data block with the same size as the operation matrix, and storing the lower triangular matrix and the upper triangular matrix in the operation data block after decomposition.

12. The Gaussian elimination computing method according to claim 11, wherein inputting the operation matrix into the systolic array to perform the matrix decomposition operation comprises:
equally dividing the operation matrix into a plurality of column group matrices, which respectively have the same number of rows as the operation matrix, and respectively inputting each of the column group matrices to the systolic array to perform the matrix decomposition operation.

13. The Gaussian elimination computing method according to claim 12, wherein respectively inputting each of the column group matrices to the systolic array to perform the matrix decomposition operation comprises:
providing a plurality of rows of each of the column group matrices to a first row of the systolic array according to a row sequence, wherein each of the rows of the systolic array receives an input row matrix from a previous row, and an operation is performed to generate an output row matrix, which is passed to a following row of each of the rows.

14. The Gaussian elimination computing method according to claim 13, wherein the systolic array comprises a plurality of operating cells, and each of the operating cells comprises:
a plurality of first operating cells, arranged on a diagonal in the systolic array; and
a plurality of second operating cells arranged at positions other than the diagonal in the systolic array,
wherein the Gaussian elimination computing method comprises:
when the systolic array operates in a triangular operation mode, the first operating cells are operated under a decomposition operation mode, the second operating cells arranged below the diagonal are turned off, each of the first operating cells generates a control signal according to a received first data value and a stored second data value, so as to control the second operating cells in the same row to perform the same operation as the first operating cell; and
when the systolic array operates in a square array operation mode, all of the operating cells are turned on, and the operating cells of each of the rows jointly receive a control signal to perform the same operation.

15. The Gaussian elimination computing method according to claim 14, wherein an operation performed by the operating cells comprises one of shifting, adding, swapping, and initiating.

16. The Gaussian elimination computing method according to claim 14, further comprising each of the first operating cells respectively checking whether each of the stored second data values is zero after completing an operation on each of the column group matrices.

17. The Gaussian elimination computing method according to claim 16, further comprising terminating the operation of the input matrix and requesting to update the input matrix when any one of the second data values is checked to be zero.

18. The Gaussian elimination computing method according to claim 12, further comprising:
wherein the systolic array is written in a first row of the memory in a manner of aligning row heads in the memory when the systolic array writes an operation result of each of the column group matrices into the memory, and the systolic array loops back to a first row of the memory and performs subsequent writes in a manner of aligning row terminals in the memory after the systolic array completes writing a last row of the memory according to a row sequence.

19. The Gaussian elimination computing method according to claim 18, further comprising receiving a selection signal through a multiplexer coupled between the systolic array and the memory, so as to selectively write an operation result of each of the column group matrices into the memory by bit.

20. The Gaussian elimination computing method according to claim 11, wherein receiving the operation matrix comprises:
receiving an input matrix, and obtaining the operation matrix and a target matrix by dividing the input matrix, wherein the input matrix, the operation matrix, and the target matrix have the same number of rows,
the Gaussian elimination computing method further comprising: recording a sorting matrix to record a sorting of all rows of the operation matrix in the matrix decomposition operation, and computing the target matrix through the systolic array according to the sorting matrix, the upper triangular matrix, and the lower triangular matrix to obtain a public key matrix.
